(19) United States
(12) Patent Application Publication
(10) Pub. No.: US 2024/0142245 A1
(43) Pub. Date: May 2, 2024

(54) METHOD AND APPARATUS FOR EXTRACTING JOURNEYS FROM VEHICLE LOCATION TRACE DATA

(71) Applicant: HERE Global B.V., Eindhoven (NL)

(72) Inventors: Basel HASHISHO, Berlin (DE); Bo XU, Lisle, IL (US); Rohit GUPTA, Son en Breugel (NL); Reinhard KOHN, Berlin (DE); Sebastian Hendrik VAN DE HOEF, Langen (DE)

(21) Appl. No.: 17/977,679

(22) Filed: Oct. 31, 2022

(51) Int. Cl. G01C 21/34; G01C 21/00

(52) U.S. Cl. CPC G01C 21/3453; G01C 21/3874

(57) ABSTRACT

An approach is provided for stop classification and journey extraction from vehicle location trace data. The approach involves, for example, processing vehicle location trace data to determine a sequence of vehicle stop locations. The sequence of vehicle stop locations comprises a first stop location, a second stop location, and a third stop location in chronological order. The approach also involves determining a first route cost (e.g., a first route length) from the first stop location to the third stop location via the second stop location and a second route cost (e.g., a second route length) from the first stop location directly to the third stop location. The approach further involves determining a classification of the second stop location as either a task stop or a rest stop based, at least in part, on a comparison of the first route length and the second route length.

### BACKGROUND

Mapping and navigation service providers often rely on vehicle location traces to provide location based services. However, because location traces are typically just a sequence of geolocations delineating a trajectory or path taken by a vehicle that are sampled over time, there generally is no explicit semantic information about the traces (e.g., when journeys begin or end, when stops are made, etc.). Accordingly, service providers face significant technical challenges to extract such information from raw location trace data.

### SOME EXAMPLE EMBODIMENTS

Therefore, there is a need for extracting journeys (and/or any other related semantic information) from vehicle location trace data.

According to one embodiment, a method comprises processing vehicle location trace data to determine a sequence of vehicle stop locations. The sequence of vehicle stop locations comprises a first stop location, a second stop location, and a third stop location in chronological order. The method also comprises determining a first route cost (e.g., route length, travel time, fuel consumption, preference for roads that support commercial vehicles, etc.) from the first stop location to the third stop location via the second stop location and determining a second route cost from the first stop location directly to the third stop location. The method further comprises determining a classification of the second stop location as either a task stop or a rest stop based, at least in part, on a comparison of the first route length and the second route length. The method further comprises providing the classification as an output. In one embodiment, the method further comprises segmenting the vehicle location trace data into one or more journeys of a vehicle represented in the vehicle location trace data. The one or more journeys, for instance, is a route segment starting from a first task stop and ending at a second task stop.

According to another embodiment, an apparatus comprises at least one processor, and at least one memory including computer program code for one or more computer programs, the at least one memory and the computer program code configured to, with the at least one processor, cause, at least in part, the apparatus to process vehicle location trace data to determine a sequence of vehicle stop locations. The sequence of vehicle stop locations comprises a first stop location, a second stop location, and a third stop location in chronological order. The apparatus is also caused to determine a first route cost (e.g., route length, travel time, fuel consumption, preference for roads that support commercial vehicles, etc.) from the first stop location to the third stop location via the second stop location and determine a second route length from the first stop location directly to the third stop location. The apparatus is further caused to determine a classification of the second stop location as either a task stop or a rest stop based, at least in part, on a comparison of the first route length and the second route length. The apparatus is further caused to provide the classification as an output. In one embodiment, the apparatus is further caused to segment the vehicle location trace data into one or more journeys of a vehicle represented in the vehicle location trace data. The one or more journeys, for instance, is a route segment starting from a first task stop and ending at a second task stop.

According to another embodiment, a non-transitory computer-readable storage medium carries one or more sequences of one or more instructions which, when executed by one or more processors, cause, at least in part, an apparatus to process vehicle location trace data to determine a sequence of vehicle stop locations. The sequence of vehicle stop locations comprises a first stop location, a second stop location, and a third stop location in chronological order. The apparatus is also caused to determine a first route cost (e.g., route length, travel time, fuel consumption, preference for roads that support commercial vehicles, etc.) from the first stop location to the third stop location via the second stop location and determine a second route length from the first stop location directly to the third stop location. The apparatus is further caused to determine a classification of the second stop location as either a task stop or a rest stop based, at least in part, on a comparison of the first route length and the second route length. The apparatus is further caused to provide the classification as an output. In one embodiment, the apparatus is further caused to segment the vehicle location trace data into one or more journeys of a vehicle represented in the vehicle location trace data. The one or more journeys, for instance, is a route segment starting from a first task stop and ending at a second task stop.

According to another embodiment, an apparatus comprises means for processing vehicle location trace data to determine a sequence of vehicle stop locations. The sequence of vehicle stop locations comprises a first stop location, a second stop location, and a third stop location in chronological order. The apparatus also comprises means for determining a first route cost (e.g., route length, travel time, fuel consumption, preference for roads that support commercial vehicles, etc.) from the first stop location to the third stop location via the second stop location and determining a second route length from the first stop location directly to the third stop location. The apparatus further comprises means for determining a classification of the second stop location as either a task stop or a rest stop based, at least in part, on a comparison of the first route length and the second route length. The apparatus further comprises means for providing the classification as an output. In one embodiment, the apparatus further comprises means for segmenting the vehicle location trace data into one or more journeys of a vehicle represented in the vehicle location trace data. The one or more journeys, for instance, is a route segment starting from a first task stop and ending at a second task stop.

In addition, for various example embodiments described herein, the following is applicable: a computer program product may be provided. For example, a computer program product comprising instructions which, when the program is executed by a computer, cause the computer to perform any one or any combination of methods (or processes) disclosed.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of extracting journeys from vehicle location trace data, according to one example embodiment;

FIG. 2 is a diagram illustrating an example journey for a logistical vehicle, according to one embodiment;

FIG. 3 is a diagram of components of a mapping platform capable of extracting journeys from vehicle location data, according to one example embodiment;

FIG. 4 is a diagram illustrating an example location trace, according to one example embodiment;

FIG. 5 is a flowchart of a process for extracting journeys from location trace data, according to one example embodiment;

FIG. 6 is a diagram illustrating an example location trace for detecting stop arrival and/or departure times, according to one example embodiment;

FIGS. 7A-7D are example histograms of inter-stop duration, according to one example embodiment;

FIG. 8 is a flowchart a process for stop classification by route-detour, according to one example embodiment;

FIGS. 9A-9C are diagrams illustrating stop locations for stop classification and verification using route-detour, according to one example embodiment;

FIG. 10 is an example plot for dynamically determining a route-detour threshold, according to one example embodiment;

FIGS. 11A and 11B are diagrams illustrating examples of stop classification based on place association, according to one example embodiment;

FIG. 12 is a diagram illustrating an example stop history of a truck, according to one example embodiment;

FIG. 13 is a diagram illustrating machine learned stop classification rules, according to one example embodiment;

FIG. 14 is a diagram of a geographic database, according to one example embodiment;

FIG. 15 is a diagram of hardware that can be used to implement an example embodiment of the processes described herein;

FIG. 16 is a diagram of a chip set that can be used to implement an example embodiment of the processes described herein; and

FIG. 17 is a diagram of a terminal that can be used to implement an example embodiment of the processes described herein.

### DESCRIPTION OF SOME EMBODIMENTS

Examples of a method, apparatus, and computer program for extracting journeys from vehicle location trace data are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. In addition, the embodiments described herein are provided by example, and as such, “one embodiment” can also be used synonymously as “one example embodiment.” Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

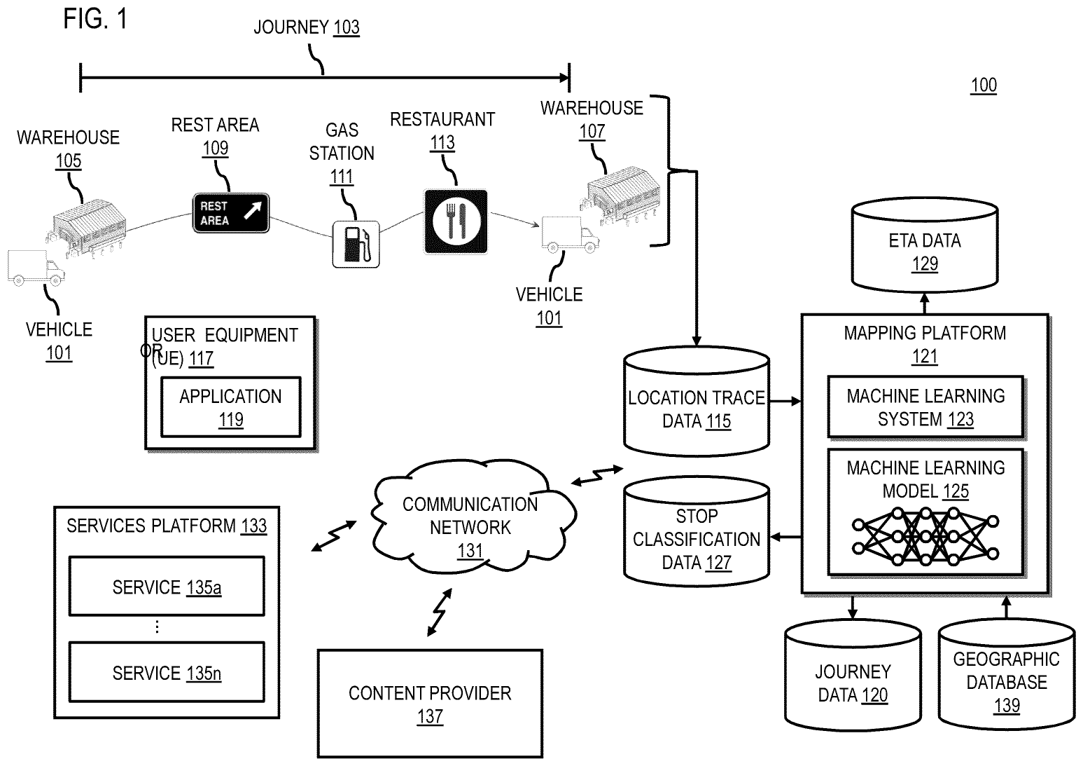

FIG. 1 is a diagram of a system 100 capable of extracting journeys from vehicle location trace data, according to one example embodiment. Providing accurate navigation and/or mapping services (e.g., accurate Estimated Time of Arrival (ETA)) is important for many fleet management and logistical operations. By way of example, logistical operations often involve a vehicle 101 (e.g., trucks and/or any other equivalent types of vehicles) that is capable of transporting goods/products, making deliveries, and/or the like. To build machine learning models for truck or other logistical vehicle ETA, data about historical journeys are usually required, where each journey 103 starts with a task stop (e.g., loading from a warehouse 105) and ends with another task stop (e.g., unloading to another warehouse 107). A logistical vehicle 101 (e.g., truck) may perform multiple rest stops in between the two task stops (e.g., at warehouses 105 and 107) for the purpose of resting (e.g., at rest stop 109), refueling (e.g., at gas station 111), eating (e.g., at restaurant 113), and/or sleeping (not shown).

In the past, journey information could only be recorded by manual logging. The widespread usage of Global Positioning System (GPS) (and other Global Navigation Satellite System (GNSS) type positioning systems) nowadays makes it an attractive source of journey data. However, utilizing this source requires extracting those journeys from the raw GPS or other position data (e.g., location trace data 115 comprising sequences of periodically sampled geolocations as vehicles 101 travel). In one embodiment, the location trace data 115 can be sampled using one or more positioning sensors or devices associated with the vehicle 101 and/or associated with a user equipment (UE) device 117 (e.g., personal navigation device, smartphone, portable terminal, tablet, etc.) associated with the vehicle 101 and executing an application 119. In this context, extracting journeys can be translated into the problem of detecting and classifying stops from location trace data 115 (e.g., GPS traces). Once the system 100 determines where a vehicle 101 stops and what reason it stops for (e.g., task stop versus rest stop), the system 100 can construct or extract journeys 103 (e.g., as journey data 120) from the location trace data 115.

In one embodiment, the system (e.g., via a mapping platform 121 alone or in combination with a machine learning system 123 and trained machine learning models 125) can detect a stop by identifying a sequence of GPS points of the location trace data 115 for a given vehicle 101 of interest that are stationary or move very slowly in a small radius (e.g., move below a speed threshold within a threshold distance radius or boundary). A more technically challenging problem is to identify the purpose of a stop and perform stop classification.

To address this technical challenge, the system 100 introduces a capability referred to herein as “route-detour” to facilitate classifying stops into task stops and rest stops (e.g., generation of stop classification data 127), and thus to facilitate journey extraction (e.g., generation of journey data 120). In other words, the various embodiments described herein relate to automatically extracting journeys 103 from vehicle location trace data 115 (e.g., truck GPS traces). As described above, each journey 103 represents a movement of a vehicle 101 (e.g., truck or other logistical vehicle) from a task place (e.g., a cargo station) to another task place, possibly with multiple stops in between for non-task purposes (e.g., resting, eating, refueling, etc.). A stop at a task place, for instance, is referred to as a “task stop” and a stop for non-task purposes is referred to as a “rest stop.” A task place, for instance, refers to location where the vehicle 101 is to perform a task designated to the vehicle 101 (e.g., make a deliver, pick up goods for transport, etc.).

In one embodiment, the system 100 begins by processing location trace data 115 collected from one or more vehicles 101 to detect stops. Then, the system 100 classifies each detected stop as a task stop or a non-task stop (e.g., to generate stop classification data 127). For stop classification, the system 100 utilizes a novel feature called route-detour and optionally combines it with a set of temporal features and place category features. In one embodiment, the system 100 further clusters detected stops and applies a majority voting (or any other equivalent arbitration process) to consolidate the classification of the member stops in each cluster. In one embodiment, the system 100 can use the journeys (e.g., journey data 120) extracted from the location trace data 115 to build and evaluate an ML-based ETA prediction model (e.g., to generate ETA data 129) and/or to provide any other location-based services. For example, the mapping platform 121 can provide the stop classification data 127, journey data 120, ETA data 129, and/or any other related data over a communication network 131 to a services platform 133, one or more services 135a-135n (also collectively referred to as services 135) of the services platform 133, one or more content providers 137, and/or any other component with connectivity to the system 100 to use the output of the system 100 and/or provide information/data for generating the output.

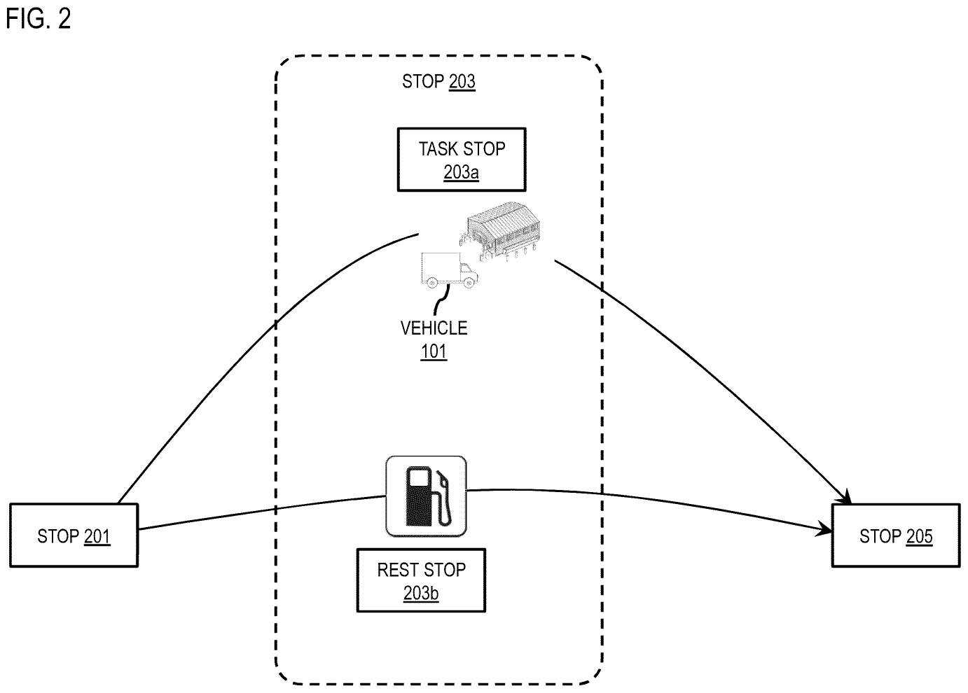

The intuition behind the various embodiments of the route-detour process is as follows: a truck or other logistical vehicle 101 usually only performs rest stops at locations that are on the way to its destination. Therefore, if a stop requires a significant detour, then this stop is likely to be a task stop. FIG. 2 is a diagram illustrating an example journey for a logistical vehicle, according to one embodiment. In the example of FIG. 2, let stop 201 (e.g., first stop), stop 203 (e.g., second stop), and stop 205 (e.g., third stop) be three stops (e.g., consecutive stops or any three stops in chronological order) of a vehicle 101. The route detour feature of stop 203 is defined to be the cost difference between a first route from stop 201 to stop 205 directly and a second route from stop 201 to stop 205 via stop 203. By way of example, it is contemplated that the cost difference can be determined based on any transport or vehicle related cost measure including but not limited include travel distance, travel time, energy consumption, road attribute, etc. The cost difference can also be based cost function used by a routing engine to determine or recommend a navigation route.

The higher or greater the cost difference between the two routes (e.g., a route a first stop and a third stop via a second stop and a direct route from the first stop to the third), the more likely stop 203 is a task stop 203a (e.g., a warehouse at which cargo is to be delivered) than a rest stop 203b (e.g., a gas station to refuel the vehicle 101). This idea is illustrated by FIG. 2, where rest stop 203b is on the way from stop 201 to stop 205 and thus requires little to no detour relative to a direct route between stop 201 and stop 205, whereas stop 203a requires a significant detour relative to the direct route between stop 201 and stop 205. Accordingly, the system 100 is configured to classify that stop 203b is likely to be a rest stop because the difference (e.g., route-detour) between the route from stops 201 and stop 205 via stop 203b and the direct route from stop 201 to stop 203 is less than a threshold value, and to classify that stop 203a is likely to be a task stop because the difference (e.g., route-detour) between the route from stop 201 and stop 205 via stop 203a and the direct route from stop 201 to stop 205 is less than a threshold value.

In one embodiment, the system 100 can combine the route-detour feature with a set of temporal features and place category features for stop classification using machine learning (e.g., via machine learning system 123 and trained machine learning models 125). In yet another embodiment, the system 100 introduces an arbitration procedure to revise the classification of a stop based on the classifications of other stops close by (e.g., within a threshold proximity). The arbitration procedure first clusters all the detected stops such that the member stops of a cluster are likely to belong to a common logical place, whether the place is a rest area, a parking lot, or a warehouse, etc. Then, the procedure consolidates the classifications of each member stop based on the majority rule (or any other equivalent arbitration or voting rules/criteria). That is, if most of the member stops are classified as task (or rest) stops, then all the member stops of the given cluster are finalized as task (or rest) stops regardless of their initial classification. The arbitration procedure reduces the impact of wrong classifications of individual stops and makes the final classification more accurate.

In summary, the various embodiments of the system 100 described herein provide for at least the following:
Introducing a novel feature called route-detour for classifying truck or other logistical vehicle stops into task stops and rest stops;
Combining the route-detour feature with a set of temporal and place category features using machine learning to provide stop classification;
Introducing an arbitration procedure to consolidate the classifications of individual stops; and
Using journeys extracted according to the various embodiments described to build and evaluate a machine learning (ML)-based ETA prediction model (and/or another location-based predictive model using journey data 120 and/or stop classification data 127 as inputs).

In one embodiment, the system 100 can use the route-detour feature to resolve stop classification ambiguities that may arise from using temporal features and place category features alone. First, a stop may have various point of interest (POI) types nearby, in which case it is technically difficult to associate the stop with the correct type. Second, many POIs can be both a task stop or a rest stop, depending on the purpose of visit. For example, a gas station is typically a rest stop, but it can be a task stop when a truck delivers gasoline to it. The route-detour feature introduced in the various embodiments described herein helps to resolve the ambiguity in such cases.

In use cases that involve predicting ETA for logistical or transport vehicles 101 (e.g., trucks), it is important for the historical trip data to contain journeys rather than arbitrary trips so that movement patterns specific to trucks or logistical vehicles 101, such as the resting behaviors, can be reflected in ETA models. Traditionally, historical trip data that is used for ETA estimation have not been broken into journeys (e.g., starting and ending at a task place). Instead, traditional historical trip data can essentially start or end at any point in a road network. Thus, in traditional historical trip data there is no need to distinguish between task stops and rest stops as is preferable for truck and other logistical use cases that do typically start and end at task places (e.g., transporting goods from one warehouse to another warehouse with possible rest stops in between).

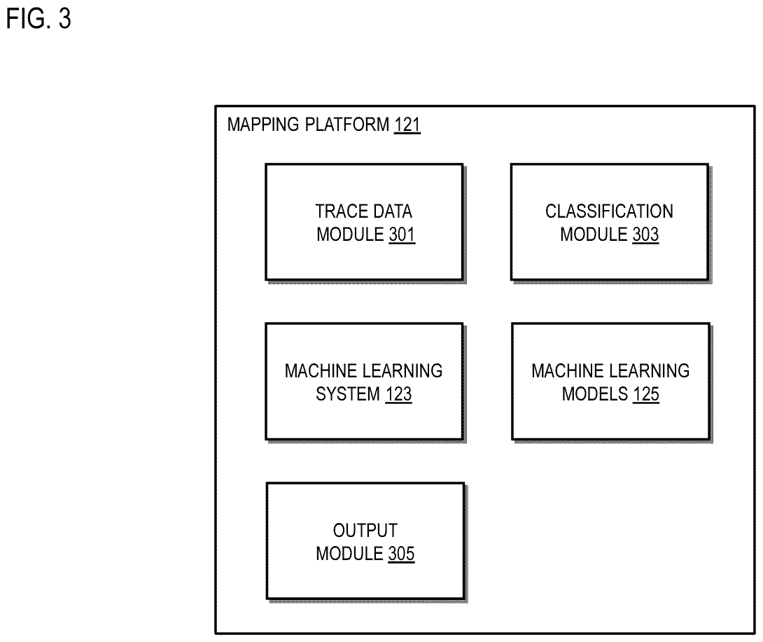

In one embodiment, the mapping platform 121 of the system 100 performs one or more functions for extracting journeys from vehicle location trace data 115. FIG. 3 is a diagram of components of the mapping platform 121 capable of extracting journey data 120 from vehicle location trace data 115 based on stop classification data 127, according to one example embodiment. In one embodiment, as shown in FIG. 3, the mapping platform 121 includes one or more components for journey extraction according to the various embodiments described herein. It is contemplated that the functions of the components of the mapping platform 121 may be combined or performed by other components of equivalent functionality. As shown, in one embodiment, the mapping platform 121 includes a trace data module 301, a classification module 303, the machine learning system 123, one or more machine learning models 125, and an output module 305. The mapping platform 121 also has connectivity to a geographic database 139 (e.g., storing digital map data) to facilitate stop classification and journey extraction according to the various embodiments described herein.

The above presented modules and components of the mapping platform 121 can be implemented in hardware, firmware, software, circuitry, or a combination thereof. Though depicted as a separate entity in FIG. 1, it is contemplated that the mapping platform 121 may be implemented as a module of any of the components of the system (e.g., services platform 133, services 135, content providers 137, vehicles 101, UEs 117, and/or the like). In another embodiment, one or more of the modules or components of the mapping platform 121 may be implemented as a cloud-based service, local service, native application, or combination thereof.

The functions of the mapping platform 121 and its modules/components are discussed with respect to figures below. The denotations and terms used in the description of the various embodiments include:

Definition 1: A GPS or location trace T is a sequence <(x₁, y₁, t₁), (x₂, y₂, t₂), . . . (xₙ, yₙ, tₙ)> where t₁<t₂< . . . <tₙ, indicating that a truck is at geolocation (x₁, y₁) at time t₁, at geolocation (x₂, y₂) at time t₂, and so on. Each point (xᵢ, yᵢ, tᵢ) is called a GPS or location point and denoted pᵢ.

Definition 2: Denote by dᵢ the great circle distance between geolocations (xᵢ, yᵢ) and (xᵢ₋₁, yᵢ₋₁). The speed of a GPS point (xᵢ, yᵢ, tᵢ), denoted vᵢ, is equal to

$$\frac{{d}_{i}}{{t}_{i} - {t}_{i - 1}} .$$

Definition 3: A real stop is an uninterrupted time period during which a truck is stationary. The start (or end) point of this time period is called the arrival (or departure) time of this real stop.

Due to random GPS errors, the GPS points sampled during a real stop vary slightly and therefore the derived speed is seldom zero. Instead, the truck usually appears to move very slowly within a small spatial range. Thus, we have the following definition to capture a real stop indicated in a GPS trace.

Definition 4: A trace-stop is a longest consecutive subsequence of T such that the speed of each GPS or location point in the trace-stop is lower than a threshold v_{low} and the total distance traveled in the trace-stop is smaller than a threshold d_{low}. In one embodiment, a subsequence S=<pₕ, pₕ₊₁, . . . , pₕ₊ₖ> is a trace-stop if the following three conditions hold:
1. vᵢ<v_{low} for every h£i£h+k (low speed criterion)
2. dₕ₊₁+dₕ₊₂+ . . . +dₕ₊ₖ<d_{low} (short distance criterion)
3. vₕ₋₁>v_{low} and vₕ₊ₖ₊₁≥v_{low} (longest subsequence criterion)

GPS point pₕ is called the head of S and pₕ₊ₖ the tail. The centroid of the geolocations in S is called the location of S.

As used herein, unless otherwise specified, the term stop refers to a trace stop.

Definition 5: A place is a geographic area with certain functionality (e.g., as queried from and/or specified in the geographic database 139 or equivalent digital map data).

For example, a rest area is a place, and so is a restaurant, a grocery store, a gas station, and a warehouse.

Definition 6: A stop is called a task stop if the truck or vehicle 101 performs the stop connected to its primary purpose of transporting goods such as loading/unloading cargo and/or any other logistical function. A stop is called a rest stop otherwise, for instance, for the driver to rest.

By way of example, warehouses are typical places where task stops occur. Rest areas, restaurants, gas stations, and hotels are typical places where rest stops occur.

Definition 7: A journey is a subsequence of T that starts at the tail of a task stop and ends at the head of a task stop, and all the stops in between if any are rest stops.

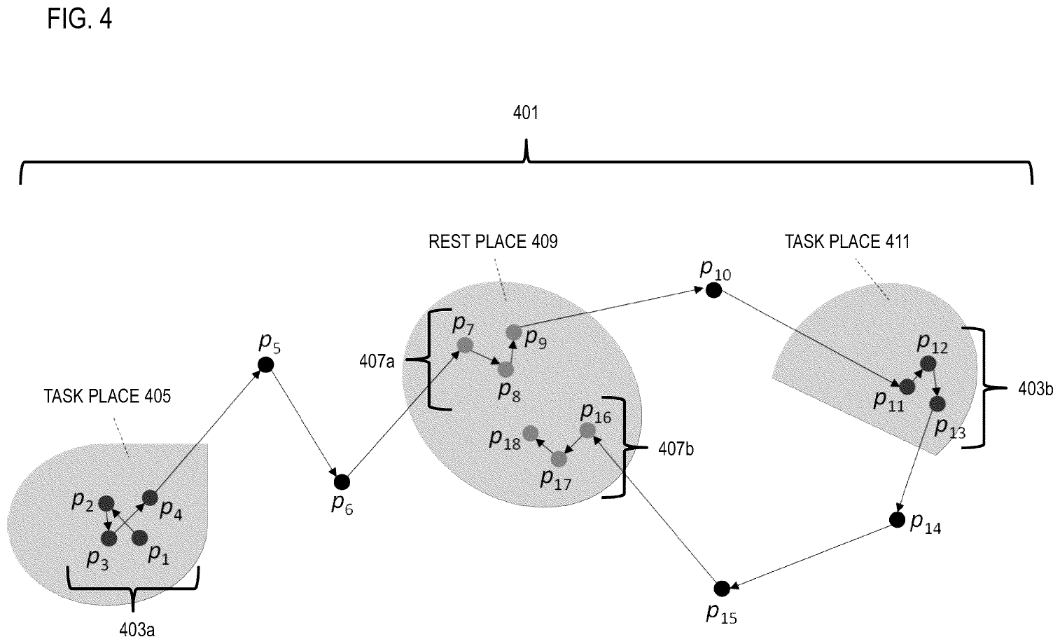

FIG. 4 is a diagram illustrating an example location trace 401 (e.g., GPS trace) for a vehicle 101, according to one example embodiment. As shown, location trace 401 includes 18 GPS or location points p₁, . . . , p₁₈. There are 4 stops in the location trace 401: (1) task stop 403a comprising <p₁, p₂, p₃, p₄> at task place 405; (2) rest stop 407a comprising <p₇, p₈, p₉> at rest place 409; (3) task stop 403b comprising <p₁₁, p₁₂, p₁₃> at task place 411; and (4) rest stop 407b comprising <p₁₆, p₁₇, p₁₈> back at rest place 409. In other words, <p₁, p₂, p₃, p₄> and <p₁₁, p₁₂, p₁₃> are task stops 403a and 403b performed at task place 405 and task place 411 respectively. Then, <p₇, p₈, p₉> and <p₁₆, p₁₇, p₁₈> are rest stops 407a and 407b both performed at rest place 409. The location trace 401 has one journey <p₄, . . . , p₁₁> that goes from task place 405 to task place 411 with a rest stop performed at place 409.

Thus, in one embodiment, the problem statement addressed by the system 100 includes but is not limited to: Given a set of GPS traces (e.g., location trace data 115), identify all the journeys (e.g., journey data 120) for each trace. Various embodiments of how the system 100 addresses this problem is further described below.

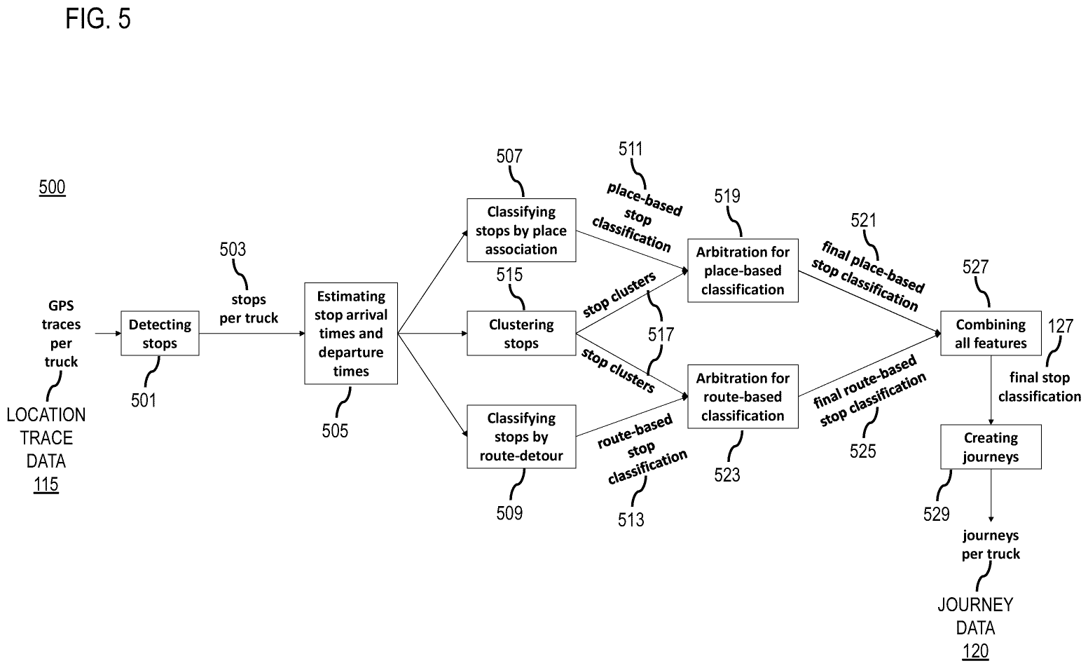

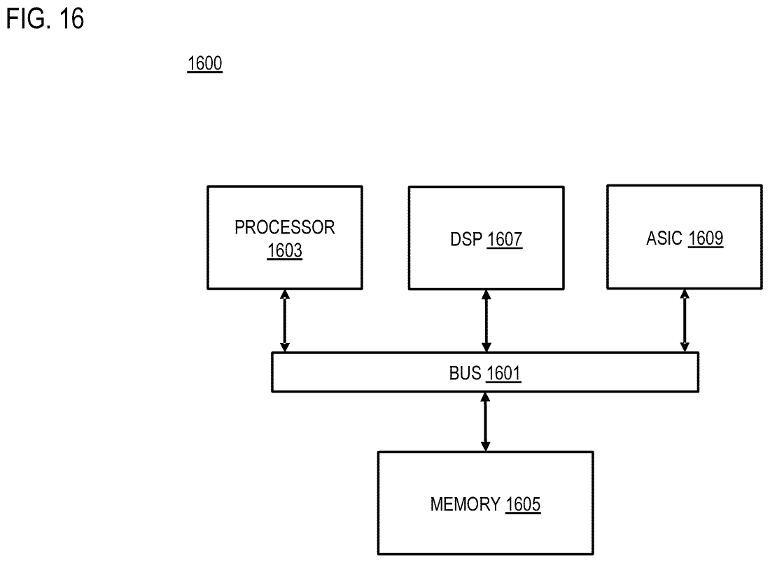

FIG. 5 is a flowchart of a process 500 for extracting journeys from location trace data 115, according to one example embodiment. In various embodiments, the mapping platform 121 and/or any of its modules/components may perform one or more portions of the process 500 and may be implemented in, for instance, a chip set including a processor and a memory as shown in FIG. 16. As such, the mapping platform 121 and/or any of its components/modules can provide means for accomplishing various parts of the process 500, as well as means for accomplishing embodiments of other processes described herein in conjunction with other components of the system 100. Although the process 500 is illustrated and described as a sequence of steps, it is contemplated that various embodiments of the process 500 may be performed in any order or combination and need not include all of the illustrated steps.

In one embodiment, the process 500 presents an overall journey extraction pipeline that includes use of route-detour based stop classification alone or in combination with other optional stop classification features (e.g., place-based classification, temporal classification, etc.). As shown, the process 500 takes as input a set of GPS or location traces (e.g., location trace data 115) and processes them in the following steps.
1. At step 501, detect stops for each GPS or location trace to identify stops 503 per truck or other logistical vehicle 101 represented in the location trace data 115.
2. At step 505, for each detected stop 503, estimate the stop arrival time and the stop departure time.
3. Classify each stop based on place association (at step 507) and route-detour (at step 509), respectively. As a result, each stop is assigned a place-based classification 511 and a route-based classification 513.
4. At step 515, cluster all the stops such that each cluster 517 contains stops that are likely to belong to a common place.
5. At step 519, within each cluster 517, finalize the place-based classification 521 for all member stops by arbitration (e.g., a majority voting and/or similar). At step 523, apply the same arbitration procedure to finalize the route-based classification 525 within each cluster 517.
6. At step 527, classify each stop as a task stop or rest stop based on multiple features, including place-based classification, route-based classification, stop arrival time, stop departure time, and stop duration to generate stop classification data 127 as the final stop classification. It is noted that although the various embodiments are discussed with respect to combining multiple features, it is contemplated that route-detour based stop classification can be used alone to determine the stop classification data 127 for the detected stops.
7. At step 529, create journeys (e.g., journey data 120) for each GPS or location trace based on stop classification results (e.g., stop classification data 127).

For illustration and not as a limitation, an example of the location trace data 115 that can be processed by the process 500 can consist of any designated number of location traces (e.g., 3,000 GPS traces) collected from multiple jurisdictions or locations (e.g., in multiple European countries). Each trace records the movement of a truck or other logistical vehicle 101 for a designated period of time (e.g., 31 consecutive days). The GPS or location sample interval can be defined at one or more designated sampling frequencies (e.g., approximately 10 minute sampling intervals). Based on the example parameters, there are a total of approximately 15 million GPS or location points in location trace data 115.

The section below provides additional details on the steps of process 500 outlined above.

At step 503, the trace data module 301 processes the location trace data 115 to detect stops 503 per truck or vehicle 101. In one embodiment, stops are detected for each trace according to Definition 4 of a trace stop defined above. For example, mapping platform determines a subsequence of each trace for which the vehicle speed is below a threshold v_{low}, and the total distance traveled is below a threshold d_{low}. In an example use case, the system 100 can set the speed threshold v_{low}=1 km/h (or any other designated value) and the distance threshold d_{low}=1 km (or any other designated value). Observe that due to the 10-minute sample interval of the in the example dataset, stops that are shorter than 10 minutes (the sampling interval) may be missed. Accordingly, the mapping platform 121 can set the sampling interval and/or threshold values based on minimum stop durations that are to be detected.

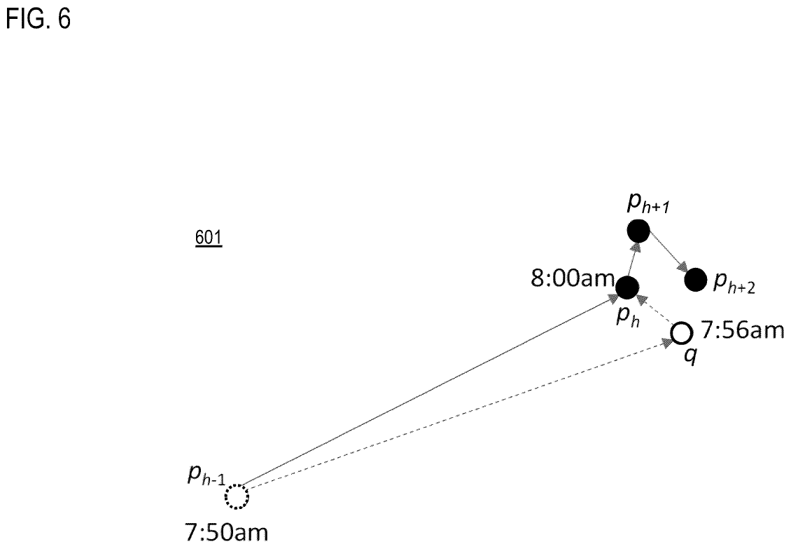

At step 505, the trace data module 301 estimates the stop arrival and/or departure times at each stop. Since a GPS or location trace is a sampling of the real movement of a truck or vehicle 101, the start/end time of a detected stop can be different than the arrival/departure time of the real stop. To see this, consider FIG. 6 which is a diagram illustrating an example location trace 601 for detecting stop arrival and/or departure times, according to one example embodiment. As shown, solid black circles are GPS or location points that constitute a stop <pₕ, pₕ₊₁, pₕ₊₂>. Point pₕ is the head, with tₕ=8:00 am. The point preceding pₕ is pₕ₋₁ (indicated by a white circle with a dashed outline) with tₕ₋₁=7:50 am. But the real stop starts at 7:56 am (at location q indicated by white circle with a solid outline). However, due to the 10-minute sample interval used in this example, q is missed, incurring a 4-minute error if the trace data module 301 estimates the stop arrival time to be pₕ. Similarly, there can be an error if the trace data module 301 estimates the stop departure time to be tₕ₊₂.

In the example of FIG. 6, a more reasonable estimate of the stop arrival time is 7:50 am plus the typical travel time from pₕ₋₁ to pₕ. In general, let pₕ be the head of a stop and pₕ₋₁ be pᵢ's predecessor. The trace data module 301 estimates the stop arrival time to be tₕ₋₁+T where T is the typical truck or vehicle 101 travel time from (xₕ₋₁,yₕ₋₁) to (xₕ,yₕ) if a truck or vehicle 101 departs at tₕ₋₁. The estimation of the stop departure time can be performed symmetrically. The vehicle travel time, for instance, can be obtained via any routing engine or algorithm used by the mapping platform 121 and/or any other equivalent navigation service (e.g., a navigation routing service 135). For example, the mapping platform 121 and/or navigation routing service 135 can provide a routing application programming interface (API) to request travel time T or other routing information. In this example, the estimated stop arrival time of a stop S is denoted by tₐᵣᵣ(S), and the estimated stop departure time is denoted by t_{dep}(S). The stop duration of S can then be defined to be t_{dep}(S)−tₐᵣᵣ(S).

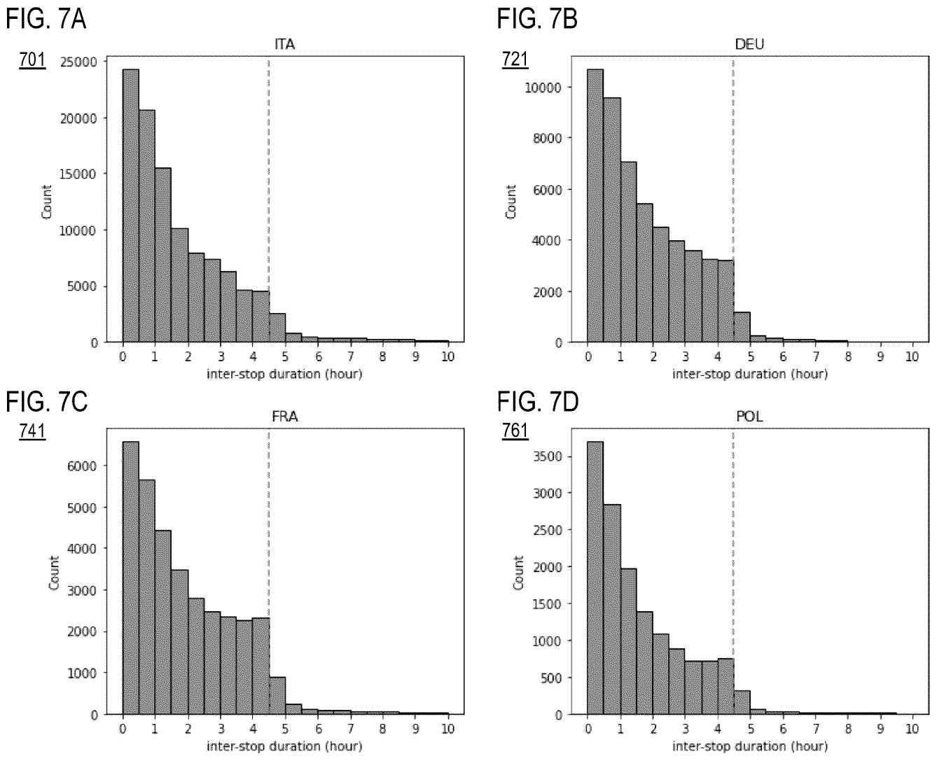

In one embodiment, to verify the various embodiments of the stop detection and stop arrival/departure time estimation methods presented above, the trace data module 301 can analyze the time durations between each pair of consecutive stops, which are referred to as inter-stop durations. Specifically, given two consecutive stops S₁ and S₂ of a trace, the inter-stop duration is equal to tₐᵣᵣ(S₂)−t_{dep}(S₁). Presumably, an inter-stop duration represents a period of continuous driving. FIGS. 7A-7D show the histograms of inter-stop durations within four respective European Union (EU) countries (e.g., Italy—ITA, Germany—DEU, France—FRA, and Poland—POL). From all the plots 701, 721, 741, and 761 in FIGS. 7A-7D, there is a drastic drop of count at the 4.5-hour inter-stop duration (marked by a vertical dashed line). This is consistent with the EU regulation that a driver must take a rest after driving for 4.5 hours. The durations beyond 4.5 hours could be due to the algorithm missing short stops, violations of the regulation, and/or stop detection errors. The EU regulation is provided by way of illustration and not as a limitation. It is contemplated that other regulations on logistical operations associated with other jurisdictions may impose different limitations on rest periods or maximum allowable driving times that can be used to verify inter-stop durations.

Next, the classification module 303 can perform stop classification of the detected stops based on route detour (at step 509) alone or in combination with place association (at stop 507). 5.3.1

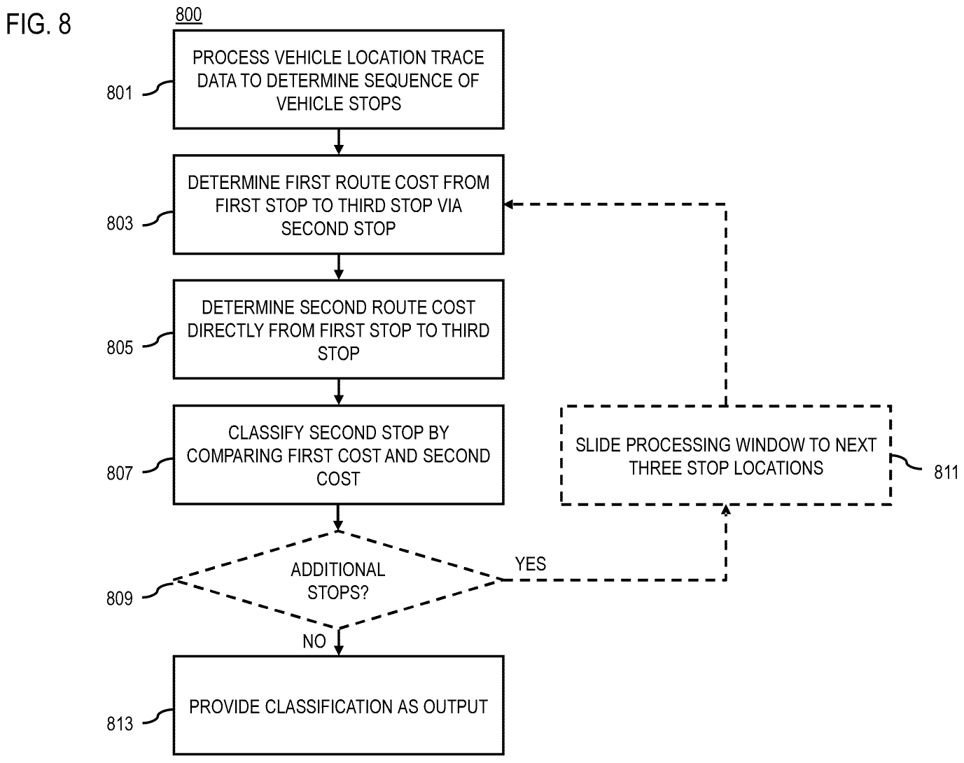

Step 509 of FIG. 5 is described in more detail with respect to a process 800 of FIG. 8 for stop classification by route-detour, according to one example embodiment. In various embodiments, the mapping platform 121 and/or any of its modules/components may perform one or more portions of the process 800 and may be implemented in, for instance, a chip set including a processor and a memory as shown in FIG. 16. As such, the mapping platform 121 and/or any of its components/modules can provide means for accomplishing various parts of the process 800, as well as means for accomplishing embodiments of other processes described herein in conjunction with other components of the system 100. Although the process 800 is illustrated and described as a sequence of steps, it is contemplated that various embodiments of the process 800 may be performed in any order or combination and need not include all of the illustrated steps.

As previously discussed, stop classification by route-detour builds on the intuition that drivers tend to take rest at places that are on the way to their next stop. If they detour a lot to perform a stop, then that stop is likely to be a task stop.

At step 801, the classification module 303 processes vehicle location trace data to determine a sequence of vehicle stop locations. In one embodiment, the vehicle location trace data is collected from one or more transport vehicles (e.g., logistical vehicles 101 such as but not limited to trucks or other vehicles carrying goods or services as part of logistical operations). Accordingly, the task stop is a stop location at which the one or more transport vehicles perform a transport or logistical function, and the rest stop is any other stop location that is not a task stop. It is noted however, that although, the vehicles 101 are discussed with respect to trucks or other logistical vehicles, it is contemplated that the various embodiments described herein are applicable to any vehicle travel scenario in which the vehicle 101 travels from a task location to another location with possible rest locations in between. The task location, for instance, can be any stop location at which the vehicle 101 is designated to perform a task, while all other stops made by the vehicle 101 is designated as rest locations (or non-task locations).

In one embodiment, the processing of step 801 is performed according to the various embodiments of step 501 of FIG. 5 for detecting stops 503. Accordingly, in this step 801, the classification module 303 can either process the location trace data 115 itself to detect stops or receive the stops 503 output generated from the process 500. In one embodiment, the sequence of vehicle stop locations comprises, at least in part, a first stop location, a second stop location, and a third stop location in chronological order. In one embodiment, the first stop location, the second stop location, and the third stop location are consecutive stop locations in the sequence of vehicle stop locations.

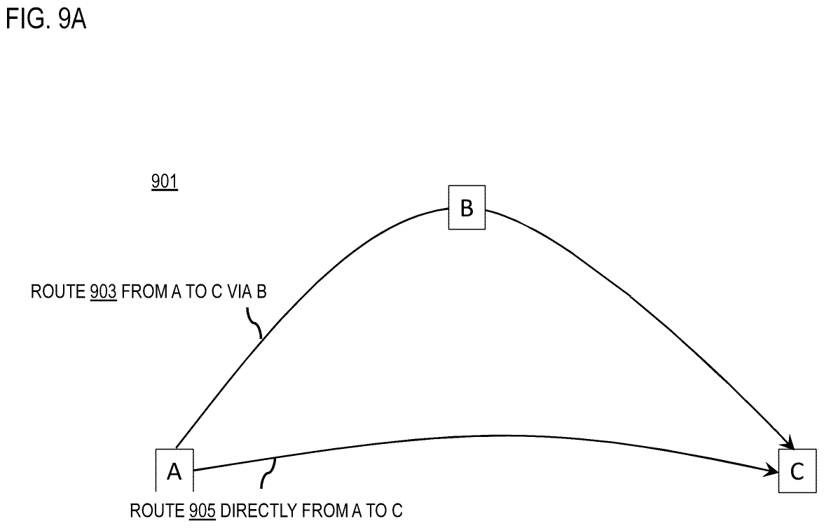

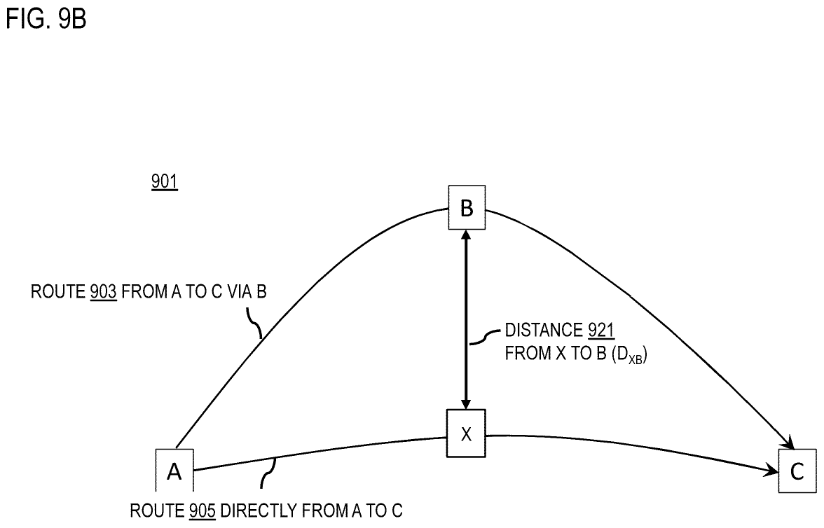

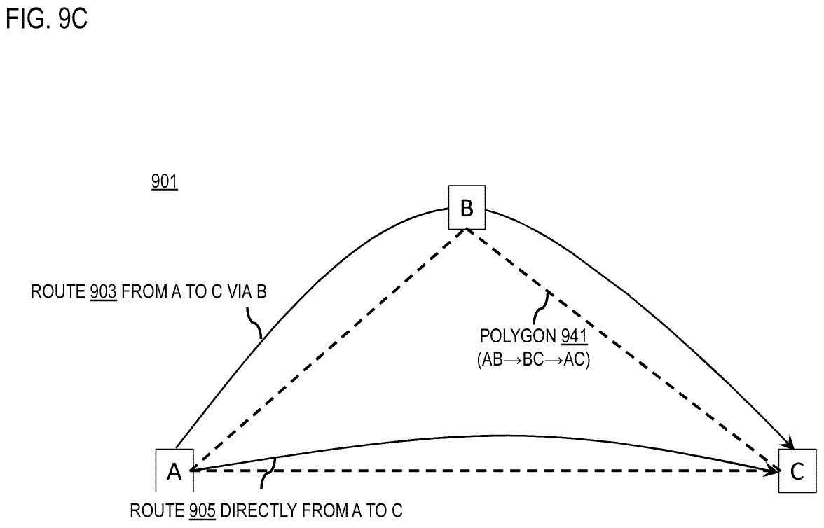

FIGS. 9A-9C are diagrams illustrating stop locations for stop classification and verification using route-detour, according to one example embodiment. In the example of FIG. 9A, route length is used as example of route cost for determining a route-detour. However, it is contemplated that the various embodiments described herein are also applicable to any cost measure including but not limited to travel time, fuel consumption, preference for roads that support commercial vehicle traffic, etc. As shown in the example stop sequence 901 of FIG. 9A, let A (e.g., a first stop), B (e.g., a second stop), and C (e.g., a third stop) be three stops (e.g., consecutive stops) traveled by a vehicle 101. The classification module 303 denotes the route cost or length of a route 903 from A to C via B by |A̅B̅C̅| and the route cost or length of a direct route 905 from A to C by |A̅C̅|. In other words, at step 803, the classification module 303 determines a first route cost (e.g., route length) from the first stop location to the third stop location via the second stop location (e.g., |A̅B̅C̅|), and at step 805, the classification module 303 determines a second route cost (e.g., route length) from the first stop location directly to the third stop location (e.g., |A̅C̅|). In one embodiment, the first route length and the second route length (or any other cost measure) are determined using a routing engine. For example, the classification module 303 can interact with a routing API (e.g., of the mapping platform 121) to compute route costs or lengths for routes 903 and 905. It is contemplated that the routing engine can determine “route cost” using any cost parameter including but not limited to route length (e.g., travel distance), travel time, fuel consumption, favoring roads accessible by commercial vehicles, etc.). In some embodiments, the first route length and the second route length (e.g., route costs) are determined based on a geometric distance. For example, the classification module 303 can determine the geocoordinates of the A, B, and C and compute the distances based on the geometric distances between each stop in route 903 (e.g., |A̅B̅C̅|) and each stop in route 905 (e.g., |A̅C̅|). In this way, no navigation routes need be computed to determine route lengths.

At step 807, the classification module 303 determines a classification of the second stop location (e.g., stop B) as either a task stop or a rest stop based, at least in part, on a comparison of the first route length and the second route length. The comparison, for instance, can be based on the difference between the two route lengths. In one embodiment, the difference in the lengths of the routes 903 and 905 (e.g., |A̅B̅C̅|−|A̅C̅|) is referred to as the route-detour.

If the route-detour for stop B (e.g., the second stop location of a three stop sequence window) is greater than a certain threshold r_{low}, the classification module 303 classifies stop B as “detour-task” or as a task stop. Otherwise (e.g., if the route-detour is shorter than the threshold r_{low}), the stop B is classified as “detour-rest” or a rest stop. In other words, in one embodiment, the second stop location is classified as the task stop based on determining that a difference between the first route cost and the second route cost (e.g., route lengths) is greater than a threshold value and a rest stop based on determining that the difference between the route costs is less than the threshold value.

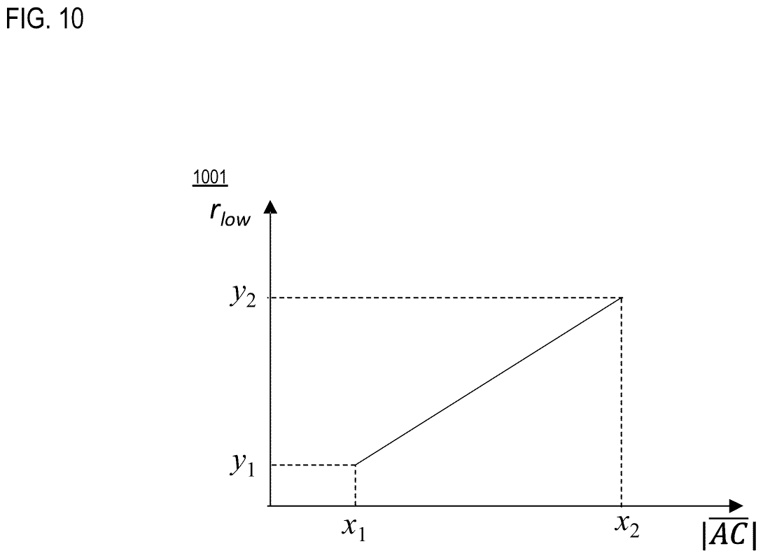

In one embodiment, the threshold r_{low} is dynamically determined based on the value of |A̅C̅| (e.g., direct route 905) as shown in plot 1001 of FIG. 10 and in the equation below:

$${r}_{l o w} = \{ \begin{matrix}{y}_{1} & \vert \overline{A C} \vert < {x}_{1} \\ {y}_{1} + \frac{{y}_{2} - {y}_{1}}{{x}_{2} - {x}_{1}} ( \vert \overline{A C} \vert - {x}_{1} ) & {x}_{1} \leq \vert \overline{A C} \vert \leq {x}_{2} \\ {y}_{2} & \vert \overline{A C} \vert > {x}_{2}\end{matrix}$$

where x₁, x₂, y₁, and y₂ are configurable parameters of the algorithm based on the length or scale of the direct route 905 (e.g., the second route cost or length referenced above). In one example use case, the parameters can be, but is not exclusively, set as x₁=10 km, x₂=400 km, y₁=2 km, y₂=8 km (e.g., with these values increasing with increasing cost or length of the direct route 905 and decreasing with decreasing cost or length of the direct route 905).

In one embodiment, the classification module 303 can use the route-detour determined based on the difference in the costs or lengths of the routes 903 and 905 (e.g., |A̅B̅C̅|−|A̅C̅|) as an initial classification. The classification module 202 can then confirm or verify the initial classification by one or more additional route deviation checks as described. For example, if the initial classification based on route-detour is that the stop of interest (e.g., stop B) is a task stop, additional checks can be performed to confirm that the stop is a task stop.

In one embodiment, the classification module 303 can determine a distance between the stop of interest (e.g., stop B) and the direct route between stop A and stop C. If the distance between stop B and the direct route is greater than a threshold value, the classification module 303 can confirm or verify that the stop classification for the stop of interest is a task stop. Otherwise, the task stop is reclassified as a rest stop (or additional checks can be performed to verify the original stop classification). FIG. 9B continues the example of FIG. 9A and illustrates and example of this classification check. In this example, a point X is selected on the direct route 905 from stop A to stop C. The classification module 303 then computes a distance 921 from point X to stop B (d_{xB}). It is contemplated that the point X and distance 921 (d_{xB}) can be selected using any means including but not limited to:
The point X on route 905 (e.g., direct from stop A to stop C) is selected as the point that is shortest radial distance (distance 921) between stop B and route 905. This radial distance can be based on geometrical distance and/or any other designated distance function.
The point X can be selected as where the common route strings AC and AB fork. The distance 921 can then be computed as the distance from point X to stop B using any cost type).
The point X can be the point on a polyline from stop A to stop C where point X is on the shortest path from point X to stop B. The distance 921 (shortest path) can be computed using any cost type.

The stop classification module 303 can then compare the computed distance 921 to a threshold value. In one embodiment, the threshold value can be dynamically computed based on the length of the route 905 (e.g., as described with respect FIG. 10). As noted, if the distance 921 is greater than the threshold value, then the stop classification can be confirmed as a task stop. If the distance 921 is less than the threshold value, then the initial stop classification is not confirmed as a task stop and the stop classification module 303 can reclassify the stop of interest as a rest stop and/or otherwise provide an indication that the initial classification is not confirmed.

Another example stop classification check comprises constructing a polygon with the stops A, B, and C at the vertices. In other words, as shown in FIG. 9C, the stop classification module 303 constructs a polygon 941 between routes or edges AB→BC→AC, and then computes the area of the polygon 941. If the area of the polygon 941 is greater a threshold value (e.g., a threshold dynamically computed based on the length of the route 905 from stop A to stop C), then the stop classification can be confirmed as a task stop. If the distance 921 is less than the threshold value, then the initial stop classification is not confirmed as a task stop and the stop classification module 303 can reclassify the stop of interest as a rest stop and/or otherwise provide an indication that the initial classification is not confirmed.

It is noted that the various embodiments of checking or confirming a stop classification described above are provided by way of illustration and not as limitations. It is contemplated that the two described checks can be used alone or in combination with each other or other equivalent classification checks. In addition, the verification checks are provided as optional checks that need not be performed such that the initial stop classification described in the embodiments above can be performed alone.

At step 809, the classification module 303 optionally determines whether there are additional stops in the location trace data 115 to process. If there are additional stops, the process proceeds to step 811. In one embodiment, the sequence of vehicle stop locations is processed using a three-stop location sliding window to determine a respective stop classification for each stop location in the sequence. Accordingly, at step 811, the classification module 303 slides the three-stop location sliding window to the next stop in the sequence and returns to step 803 to continue processing the sequence.

At step 813, if there are no additional stops to process in the sequence (e.g., no stops remain or a stopping criterion is met), the output module 305 provides the classification as an output. In one embodiment, the output can be used as one feature in an ensemble model (e.g., machine learning model 125) to determine the final stop classification output (e.g., stop classification data 127). In embodiments in which the route-detour based stop classification is used as the only determining feature, the output can be provided as the final stop classification data 127.

In one embodiment, the output module 305 can store the classification as an attribute of the second stop location (e.g., stop B) in the geographic database 139 or data layer thereof (or any other equivalent data store). The stop classification data 127 stored in the geographic database 139 can then be made available to end user devices (e.g., vehicle 101, UEs 117, etc.) and/or other services/components that use the output to provide service functions (e.g., services platform 133, services 135, content providers 137, etc.).

In embodiments in which the route-based stop classification of step 509 of FIG. 5 and process 800 of FIG. 8 are used in combination with other features for stop classification, the classification module 303 returns to step 507 of FIG. 5 to perform stop classification by place association. For example, at step 509, the classification module 303 queries a geographic database to determine one or more places within a threshold proximity of the second stop location. The classification of the stop location (e.g., the second stop location or stop B in the three stop sequence being evaluated) is further based on the one or more places. This step, for instance, searches for places of relevant categories near a stop and classifies the stop based on the search results. In one embodiment, the classification module 303 can use a geocoding and search API of the mapping platform 121 (or equivalent) for place searching of the digital map data of the geographic database 139. By way of example, in a logistics or transport use case, examples of relevant place search categories include but are not limited to: “rest-area”, “fueling-station”, “parking”, “ferry”, “hotel-motel”, “eat-drinking”, “cargo-transportation”, and/or the like. For example, the category “cargo-transportation” refers to a facility that handles some aspect of the transportation of cargo freight, such as a cargo center, a courier station, a loading dock, or a delivery entrance. Thus, in one example but not exclusive use case, “cargo-transportation” indicates a task stop; all the other relevant categories indicate a rest stop.

In one embodiment, a stop may belong to a place that is of a category that is not included in the relevant categories. For example, a supermarket is of categories “grocery” and “pharmacy”. In this case, the stop can be classified as “place-undetermined”.

In one embodiment, an example procedure of place-based stop classification is as follows.
1. Search the geographic database 139 or equivalent for places in designated categories of interest (e.g., “rest-area”, “fueling-station”, “hotel-motel”, “eta-drinking”, “cargo-transportation” places) within a threshold proximity (e.g., 150 meters) from the stop location. In some embodiments, the search threshold proximity can vary depending on the place category. For example, the classification module 303 can search “parking”, “ferry” places within a larger threshold proximity (e.g., 200 meters versus 150 meters) from the stop location. In this example, “parking” and “ferry” use a larger search radius because they usually occupy a larger space than places in other categories.
2. If no place is found at step 1, then classify the stop as “place-undetermined”.
3. If one or more places are found at step 1, find the place that is closest to the stop. If this place is “cargo-transportation”, then classify the stop as “place-task” or as a task place/stop; otherwise classify it as “place-rest” or as a rest place/stop.

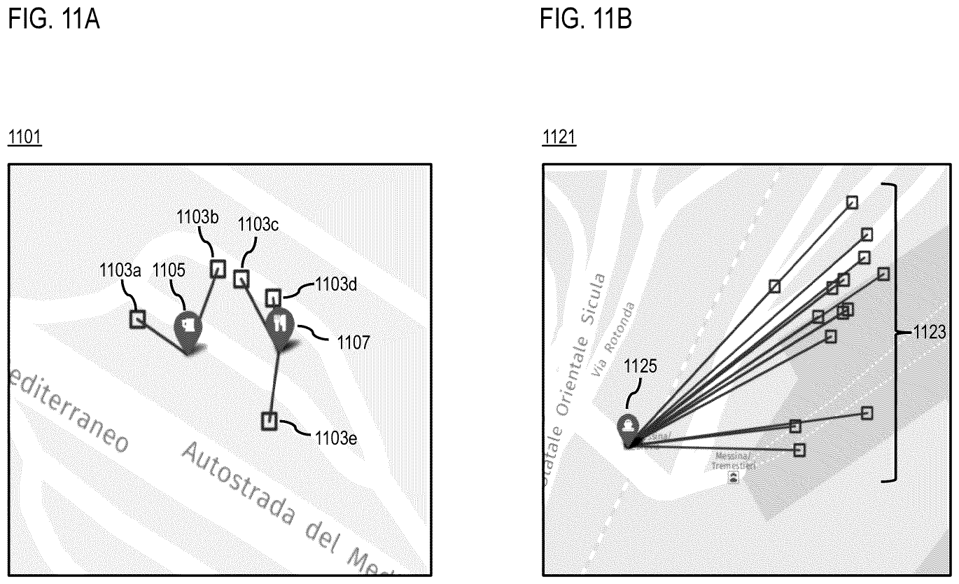

FIGS. 11A and 11B are diagrams illustrating examples of stop classification based on place association, according to one example embodiment. In example 1101 of FIG. 11A, stops 1103a-1103e have been detected (e.g., indicated by squares). A proximity search for places results in determining that a gas station 1105 is located within threshold proximity of stops 1103a and 1103b, and that a restaurant 1107 is within threshold proximity of stops 1103c-1103e. Both the gas station 1105 and restaurant 1107 are places that are not associated the “cargo-transportation” category. Accordingly, the classification module 303 determines that the place-based stop classification for stops 1103a-1103e is “place-rest” (e.g., rest stops).

In example 1121 of FIG. 11B, a set of stops 1123 have been detected (indicated by squares). A proximity search of places results in determining that a ferry terminal 1125 is within threshold proximity of the stops 1123. In this case, the ferry terminal 1125 is associated with the “cargo-transportation” category. Accordingly, the classification module 303 determines that the place-based stop classification for stops 1123 is “place-task” (e.g., task stops).

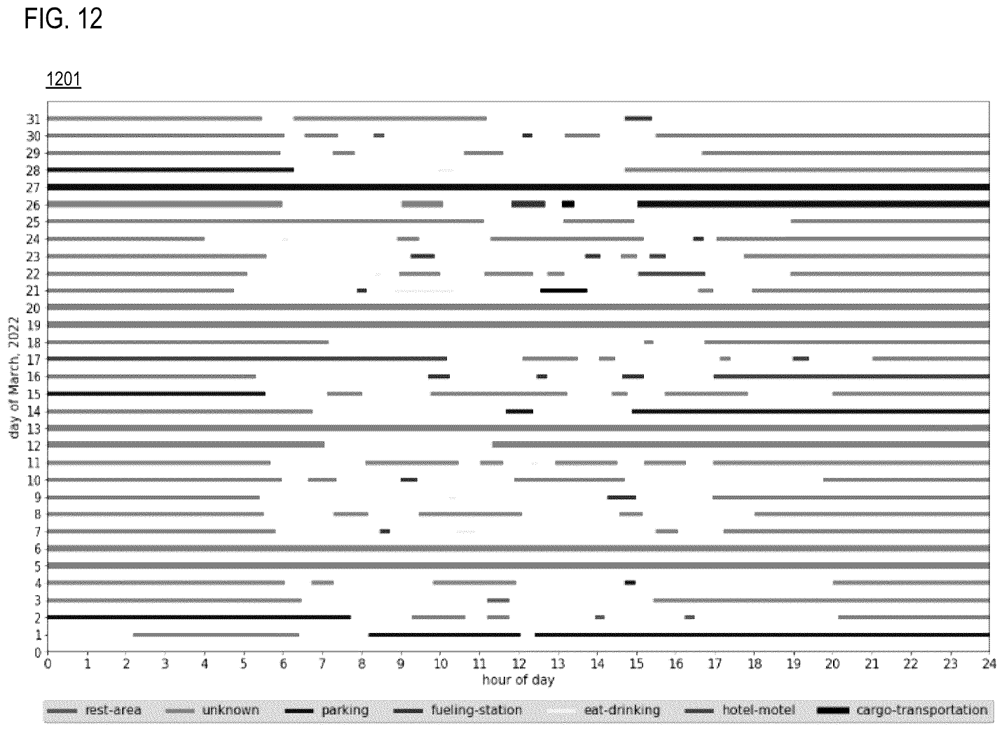

FIG. 12 is a diagram illustrating an example stop history 1201 of a truck, according to one example embodiment. In this example, each row shows the timeline of a day (24 hours) of March 2022. Each bar represents the duration of one stop, shaded by the place category they are associated with. The gaps between bars represent driving. The truck appears to have a regular pattern that it drives during daytime and rests during nighttime. Furthermore, the truck rests a lot during weekends (thick lines) and never drives for more than 9 hours (e.g., following the EU working time regulations). FIG. 12 also shows that many stops are place-undetermined. This does not necessarily mean that these stops do not belong to any places. More likely, it means that they belong to a category that is not included in the relevant categories. For these stops, the classification module 303 can let the classification be decided by the route-detour feature and/or other features discussed herein (e.g., temporal features) as described in more detail further below.

At step 515, the classification module 303 can cluster multiple or a plurality of observations of a stop in the location trace data 115 (e.g., multiple vehicles visiting the same stop or multiple visits by the same vehicle 101 to the same stop). It is contemplated that the classification module 303 can use any means to cluster the plurality of observations of a given stop (e.g., the second stop of a three-stop sequence being analyzed). For example, to cluster all stops and places, the classification module 303 can apply a clustering algorithm such as but not limited to Ordering Points to Identify Cluster Structure (OPTICS), Density-Based Spatial Clustering of Applications with Noise (DBSCAN), K-Nearest Neighbor (KNN), or equivalent. The output of the clustering is a set to stop clusters 517.

For each cluster 517, the classification module 303 can conduct a plurality-voting based on the route-based classification 513 of each member stop (e.g., via arbitration for route-based classification at step 523), and then assign the voting result to all the member stops of the cluster (e.g., final route-based stop classification 525). For example, if the majority of the stops in the cluster 517 are detour-task, then all the stops in the cluster 517 are assigned as detour-task. Similarly, the classification module 303 conducts a plurality-voting based on place-based classification (e.g., via arbitration for place-based classification at step 519) and assign the voting result to all the member stops of the cluster 517 (e.g., final place-based stop classification 521). As a result, each stop is assigned a final route-based classification 525 and a final place-based classification 521.

At step 527, the classification module 303 combines the stop features described above (e.g., final route-based stop classification 529, final place-based stop classification 521, stop arrival time, stop departure time, inter-stop duration between a stop of interest and another stop location, etc.) to generate the final stop classification (e.g., stop classification data 127) for the stops 503 detected in the location trace data 115. In one embodiment, the classification module 303 takes an ML approach (e.g., by interacting with the machine learning system 123 and machine learning models 125) to combine the one or more features listed in Table 1 below for stop classification.

TABLE 1

| Feature | Description |
|---|---|
| Route-based classification | Stop classification determined by |
| | route-detour |
| Place-based classification | Stop classification determined by place |
| | association |
| Stop arrival hour | Hour of day of the stop arrival time, ranging |
| | from 0 to 23 |
| Stop departure hour | Hour of day of the stop departure time, |
| | ranging from 0 to 23 |
| Stop duration | Stop duration in hours |
| Overnight | Whether the stop period crosses midnight |
| Inter-stop duration | Time between two stops in a trace (e.g., two |
| | consecutive stops) |

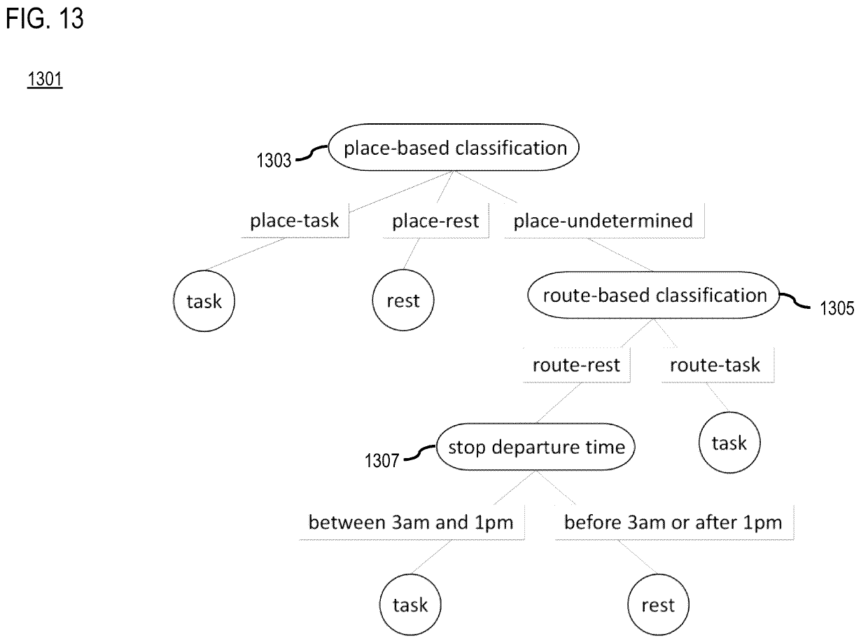

In one embodiment, to prepare a dataset for ML training and test, the machine learning system 123 manually labels stops in the dataset (e.g., labeled by human inspection of satellite images and street views). The stops, for instance, are labeled with ground truth task stops and rest stops. The machine learning system 123 splits the labeled stops into a training dataset and a test dataset. It is contemplated that the machine learning system 123 can use any ML learning algorithm (e.g., supervised, unsupervised, etc.) or model type (e.g., decision tree, Random Forest, neural network, etc.) to create a trained machine learning classifier or model 125 to predict stop classifications. By way of illustration and not as a limitation, the machine learning system 123, for instance, can use the J48 implementation of the C4.5 decision tree algorithm to machine learn the stop classification rules shown in FIG. 13. In one embodiment, a trained machined learning model 125 is a model with parameters adjusted to make accurate predictions (e.g., above a target accuracy level, for instance, with respect to the test or validation data). The trained machine learning model 125 is then used to combine the input features (e.g., one or more features of Table 1) to determine the final classification of the stops detected in the location trace data 115 as either task stops or rest stops (e.g., stop classification data 127).

As shown, the machine-learned rules of the decision tree 1301 of FIG. 13 suggest the following:
1. Place-classification 1303 is relatively reliable when an association to a relevant category can be made;
2. When an association cannot be made, route-classification 1305 is most useful, followed by stop departure time 1307; and
3. Stop arrival time and overnight features are the least useful for classification.

It is noted that the decision tree 1301 and what it suggests above are provided as examples. It is contemplated the rules illustrated in decision tree 1301 can be arranged in any order or include other features relevant to stop classification (e.g., features listed in Table 1 and/or otherwise discussed in the various embodiments described herein).

In one embodiment, the route-based classifier and place-based classifier can be created as separate machine learning models 125 or classifiers. Then their outputs can be combined by another classifier. Alternatively, the system 100 can combine route-based features and place-based features directly and build a single classifier that takes all these features as input to predict stop classifications. This alternative would also eliminate the need for the thresholding of detour in route-based classification.

At step 529, once stops are classified, journeys (e.g., journey data 120) can be straightforwardly constructed according to the journey definition (see Definition 7 above). For example, let J=<pᵢ, pᵢ₊₁, . . . , pⱼ> be a journey 103, Sᵢ be the stop that pᵢ belongs to, and Sⱼ be the stop that pⱼ belongs to (note that each of pᵢ and pⱼ must belong to a task stop according to the definition of journey discussed above). Sᵢ and Sⱼ are referred to as the source stop and the destination stop of J, respectively. t_{dep}(Sᵢ) and tₐᵣᵣ(Sⱼ) are referred to as the journey departure time and the journey arrival time of J, respectively. tₐᵣᵣ(Sⱼ)−t_{dep}(Sᵢ) is referred to as the journey duration of J. (xᵢ, yᵢ), and (xⱼ, yⱼ) are referred to as the source location and the destination location of J, respectively.

In one embodiment, the journey data 120 generated according to the various embodiments described herein can be used from any location-based service. One example service is ETA estimation (e.g., to generate ETA data 129) for trucks or other logistical vehicles 101. In one embodiment, the system 100 can apply the journey data 120 to build an ML-based model for truck ETA prediction. Given a journey J, an ETA query asks for an estimated arrival time at the destination location of J. Since the estimated arrival time is equal to the journey departure time plus an estimated journey duration, answering an ETA query is equivalent to estimating the journey duration. For this reason, in the rest of this paper we will use the two terms, ETA and estimated journey duration, interchangeably.

In one embodiment, the journey data 120 can used to train one or more machine learning models 125 to perform at least any of the following three ETA prediction methods:
Driving Time Prediction (DTP). This method predicts ETA by predicting the driving time from the journey source location to the journey destination location without accounting for rest times.
Rest-Rule (RR). This method first uses DTP to predict a driving time. Then it adds upon the driving time a rest time based on an EU rest time regulation (or equivalent regulation from a jurisdiction corresponding to where the vehicle 101 is operated). This EU regulation requires that a truck driver must rest for at least 45 minutes after a driving period of 4.5 hours. Thus, the RR method adds 45 minutes to ETA for every 4.5 hours of the driving time returned by DTP.
Extreme Gradient Boosting (XGB). This method builds an XGBoost model based on journeys extracted by START. The model uses the following features of a journey:
   DTP-ETA: the driving time in hour predicted by DTP;
   Start-hour: the hour of day of the journey departure time, ranging from 0 to 23;
   Source-duration: the duration in seconds of the source stop of the journey;
   Day of week: the day of week of the journey departure time, ranging from 0 (Monday) to 6 (Sunday).

To distinguish from the features used for stop classifications, the above features ETA-features when used for training machine learning models 125. In one embodiment, multiple different loss functions and/or supervision schemes can be used alternatively or together to train the machine learning model 125 to determine ETA predictions based on training data set described in the above embodiments. One example scheme is based on supervised learning. For example, in supervised learning, the machine learning system 123 can incorporate a learning model (e.g., a logistic regression model, Random Forest model, and/or any equivalent model) to train the machine learning model 125 to make predictions (e.g., ETA predictions) from input ETA features. During training, the machine learning system 123 can feed feature sets from a training data set into the machine learning model 125 to compute a predicted ETA using an initial set of model parameters. The machine learning system 123 then compares the predicted matching probability and the predicted ETA to ground truth data in the training data set for each training example used for training. The machine learning system 123 then computes an accuracy of the predictions (e.g., via a loss function) for the initial set of model parameters. If the accuracy or level of performance does not meet a threshold or configured level, the machine learning system 123 incrementally adjusts the model parameters (e.g., via back propagation and gradient descent) until the machine learning model 125 generates predictions at a desired or configured level of accuracy with respect to the annotated labels in the training data (e.g., the ground truth data). In the case of a neural network, the model paraments can include, but are not limited, to the coefficients or weights assigned to each connection between neurons in the layers of the neural network.

The various embodiments for automatically extracting journey information from vehicle location trace data 115 provides for several technical advantages including but not limited to:
1. The approach described herein achieves more accurate stop classification compared with a method that uses only temporal features and place features, due to the addition of the route-detour feature.
2. By clustering and arbitration, the approach described herein utilizes repeated stop visits for more accurate stop classification.
3. On the other hand, the approach does not rely on repeated visits to make stop classifications (only for optional clustering and arbitration in item 2) which makes the approach less sensitive to data density in terms of repeated visits.
4. The approach described herein increases journey duration accuracy by rectifying the stop arrival/departure time errors caused by sparse location sampling.
5. The approach described herein enables development and evaluation of ML-based ETA models tailored to trucks or other logistical vehicles 101.

Returning to FIG. 1, as shown, the system includes the mapping platform 121 operating alone or in combination with the machine learning system 123 for journey extraction from vehicle location trace data 115 according to the various embodiments described herein. In one embodiment, the machine learning system 123 of the mapping platform 121 includes or is otherwise associated with one or more machine learning models 125 (e.g., decision trees, neural networks, or other equivalent network using algorithms such as but not limited to an evolutionary algorithm, reinforcement learning, or equivalent) for stop classification, journey extraction, ETA prediction, etc.

In one embodiment, the mapping platform 121 has connectivity over the communication network 131 to the services platform 133 that provides one or more services 135 that can use stop classification data 127, journey data 120, ETA data 129, and/or other data generated by the system 100. By way of example, the services 135 may be third party services and include but is not limited to mapping services, navigation services, travel planning services, notification services, social networking services, content (e.g., audio, video, images, etc.) provisioning services, application services, storage services, contextual information determination services, location based services, information based services (e.g., weather, news, etc.), etc. In one embodiment, the services 135 uses stop classification data 127, journey data 120, ETA data 129 and/or other data generated by the mapping platform 121 to provide services 135 such as navigation, mapping, other location-based services, etc. to the vehicles 101, UEs 117, and/or applications 119 executing on the UEs 117.

In one embodiment, the mapping platform 121 may be a platform with multiple interconnected components. The mapping platform 121 may include multiple servers, intelligent networking devices, computing devices, components, and corresponding software for providing spatial aggregation for location-based services according to the various embodiments described herein. In addition, it is noted that the mapping platform 121 may be a separate entity of the system 100, a part of the one or more services 135, a part of the services platform 133, or included within components of the vehicles 101 and/or UEs 117.

In one embodiment, content providers 137 may provide content or data (e.g., including geographic data, etc.) to the geographic database 139, mapping platform 121, machine learning system 123, the services platform 133, the services 135, the vehicles 101, the UEs 117, and/or the applications 119 executing on the UEs 117. The content provided may be any type of content, such as machine learning models, location trace data, trip data, map embeddings, map content, textual content, audio content, video content, image content, etc. In one embodiment, the content providers 137 may provide content that may aid in journey extraction from location trace data or stop classification according to the various embodiments described herein. In one embodiment, the content providers 137 may also store content associated with the mapping platform 121, machine learning system 123, geographic database 139, services platform 133, services 135, and/or any other component of the system 100. In another embodiment, the content providers 137 may manage access to a central repository of data, and offer a consistent, standard interface to data, such as a repository of the geographic database 139.

In one embodiment, the vehicles 101 and/or UEs 117 may execute software applications 119 to use or access stop classification data 127, journey data 120, ETA data 129, etc. according the embodiments described herein. By way of example, the applications 119 may also be any type of application that is executable on the vehicles 101 and/or UEs 117, such as autonomous driving applications, mapping applications, location-based service applications, navigation applications, device control applications, content provisioning services, camera/imaging application, media player applications, social networking applications, calendar applications, and the like. In one embodiment, the applications 119 may act as a client for the mapping platform 121 and perform one or more functions associated with stop classification and/or journey extraction alone or in combination with the mapping platform 121.

By way of example, the vehicles 101 and/or UEs 117 is or can include any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the vehicles 101 and/or UEs 117 can support any type of interface to the user (such as “wearable” circuitry, etc.). In one embodiment, the vehicles 101 and/or UEs 117 may be associated with or be a component of a vehicle or any other device.

In one embodiment, the communication network 131 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, 5G New Radio networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the mapping platform 121, machine learning system 123, services platform 133, services 135, vehicles 101 and/or UEs 117, and/or content providers 137 communicate with each other and other components of the system 100 using well known, new or still developing protocols. In this context, a protocol includes a set of rules defining how the network nodes within the communication network 131 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

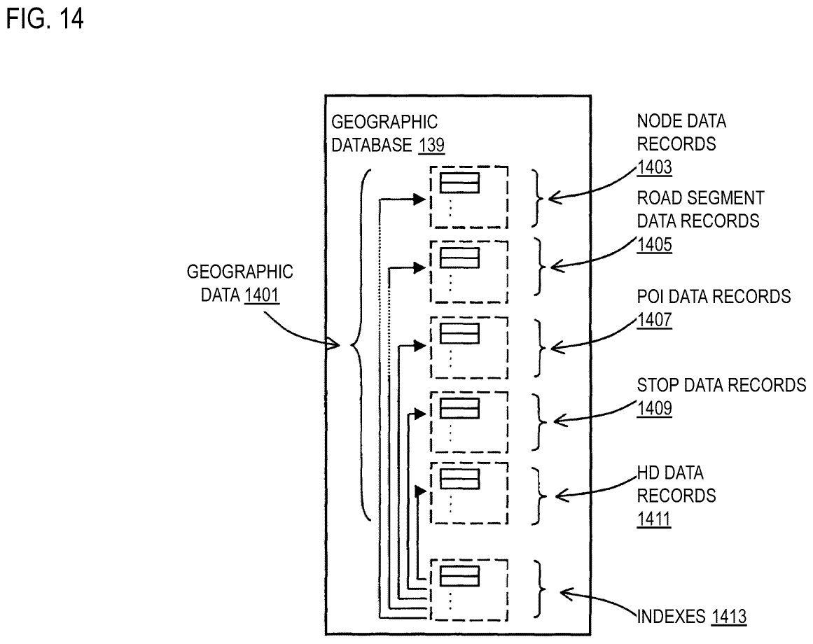

FIG. 14 is a diagram of a geographic database, according to one embodiment. In one embodiment, the geographic database 139 includes geographic data 1401 used for (or configured to be compiled to be used for) mapping and/or navigation-related services, such as for providing map embedding analytics according to the embodiments described herein. For example, the map data records stored herein can be used to determine the semantic relationships among the map features, attributes, categories, etc. represented in the geographic data 1401. In one embodiment, the geographic database 139 include high definition (HD) mapping data that provide centimeter-level or better accuracy of map features. For example, the geographic database 139 can be based on Light Detection and Ranging (LiDAR) or equivalent technology to collect billions of 3D points and model road surfaces and other map features down to the number lanes and their widths. In one embodiment, the HD mapping data (e.g., HD data records 1411) capture and store details such as the slope and curvature of the road, lane markings, roadside objects such as signposts, including what the signage denotes. By way of example, the HD mapping data enable highly automated vehicles to precisely localize themselves on the road.

In one embodiment, geographic features (e.g., two-dimensional or three-dimensional features) are represented using polylines and/or polygons (e.g., two-dimensional features) or polygon extrusions (e.g., three-dimensional features). In one embodiment, these polylines/polygons can also represent ground truth or reference features or objects (e.g., signs, road markings, lane lines, landmarks, etc.) used for visual odometry. For example, the polylines or polygons can correspond to the boundaries or edges of the respective geographic features. In the case of a building, a two-dimensional polygon can be used to represent a footprint of the building, and a three-dimensional polygon extrusion can be used to represent the three-dimensional surfaces of the building. Accordingly, the terms polygons and polygon extrusions as used herein can be used interchangeably.

In one embodiment, the following terminology applies to the representation of geographic features in the geographic database 139.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 139 follows certain conventions. For example, links do not cross themselves and do not cross each other except at a node. Also, there are no duplicated shape points, nodes, or links. Two links that connect each other have a common node. In the geographic database 139, overlapping geographic features are represented by overlapping polygons. When polygons overlap, the boundary of one polygon crosses the boundary of the other polygon. In the geographic database 139, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 139 includes node data records 1403, road segment or link data records 1405, POI data records 1407, stop data records 1409, HD mapping data records 1411, and indexes 1413, for example. More, fewer, or different data records can be provided. In one embodiment, additional data records (not shown) can include cartographic (“carto”) data records, routing data, and maneuver data. In one embodiment, the indexes 1413 may improve the speed of data retrieval operations in the geographic database 139. In one embodiment, the indexes 1413 may be used to quickly locate data without having to search every row in the geographic database 139 every time it is accessed. For example, in one embodiment, the indexes 1413 can be a spatial index of the polygon points associated with stored feature polygons.

In exemplary embodiments, the road segment data records 1405 are links or segments representing roads, streets, or paths, as can be used in the calculated route or recorded route information for determination of one or more personalized routes. The node data records 1403 are end points (for example, representing intersections or an end of a road) corresponding to the respective links or segments of the road segment data records 1405. The road link data records 1405 and the node data records 1403 represent a road network, such as used by vehicles, cars, and/or other entities. Alternatively, the geographic database 139 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 139 can include data about the POIs and their respective locations in the POI data records 1407. The geographic database 139 can also include data about places, such as cities, towns, or other communities, and other geographic features, such as bodies of water, mountain ranges, etc. Such place or feature data can be part of the POI data records 1407 or can be associated with POIs or POI data records 1407 (such as a data point used for displaying or representing a position of a city).

In one embodiment, the geographic database 139 can also include stop data records 1409 for storing detected stops, stop classification data 127, journey data 120, ETA data 129, machine learning models, machine learning model parameters, and/or any other related data that is used or generated according to the embodiments described herein. By way of example, the stop data records 1409 can be associated with one or more of the node records 1403, road segment records 1405, and/or POI data records 1407 to associate the stop classification data 127, journey data 120, ETA data 129, etc. with specific places, POIs, geographic areas, and/or other map features. In this way, the stop data records 1409 can also be associated with the characteristics or metadata of the corresponding records 1403, 1405, and/or 1407.

In one embodiment, as discussed above, the HD mapping data records 1411 model road surfaces and other map features to centimeter-level or better accuracy. The HD mapping data records 1411 also include ground truth object models that provide the precise object geometry with polylines or polygonal boundaries, as well as rich attributes of the models. These rich attributes include, but are not limited to, object type, object location, lane traversal information, lane types, lane marking types, lane level speed limit information, and/or the like. In one embodiment, the HD mapping data records 1411 are divided into spatial partitions of varying sizes to provide HD mapping data to end user devices with near real-time speed without overloading the available resources of the devices (e.g., computational, memory, bandwidth, etc. resources).

In one embodiment, the HD mapping data records 1411 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 1411.

In one embodiment, the HD mapping data records 1411 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time data (e.g., including probe trajectories) also at centimeter-level accuracy. Other sensor data can include vehicle telemetry or operational data such as windshield wiper activation state, braking state, steering angle, accelerator position, and/or the like.

In one embodiment, the geographic database 139 can be maintained by the content provider 137 in association with the services platform 133 (e.g., a map developer). The map developer can collect geographic data to generate and enhance the geographic database 139. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 139 can be a master geographic database stored in a format that facilitates updating, maintenance, and development. For example, the master geographic database or data in the master geographic database can be in an Oracle spatial format or other format (e.g., capable of accommodating multiple/different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF)) to organize and/or configure the data for performing navigation-related functions and/or services, such as route calculation, route guidance, map display, speed calculation, distance and travel time functions, and other functions, by a navigation device, such as by a vehicles 101 and/or UEs 117. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing stop classification and journey extraction may be advantageously implemented via software, hardware (e.g., general processor, Digital Signal Processing (DSP) chip, an Application Specific Integrated Circuit (ASIC), Field Programmable Gate Arrays (FPGAs), etc.), firmware, circuitry, or a combination thereof. Such exemplary hardware for performing the described functions is detailed below.

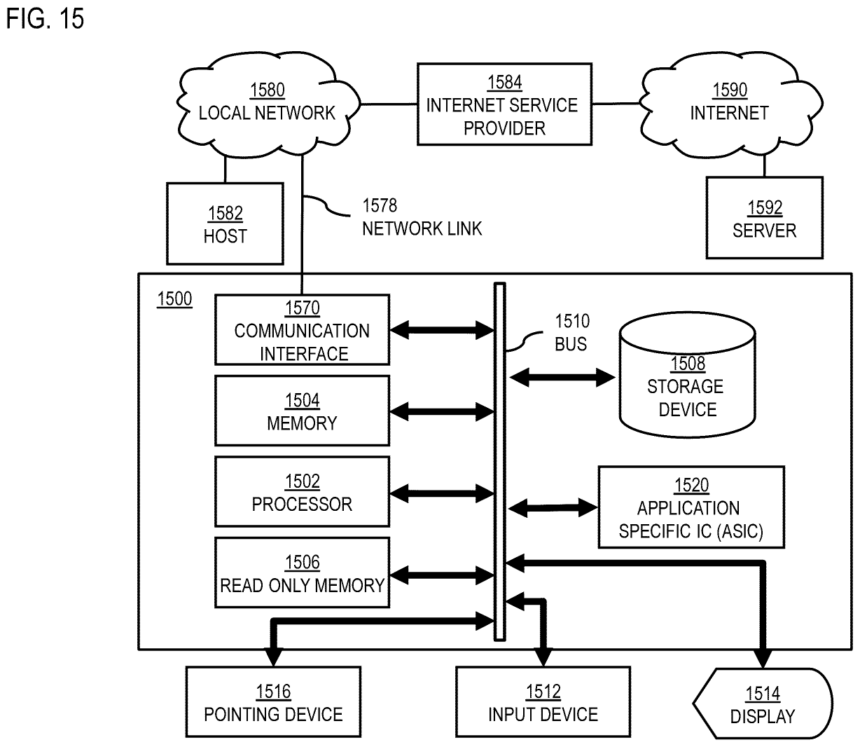

FIG. 15 illustrates a computer system 1500 upon which an embodiment of the invention may be implemented. Computer system 1500 is programmed (e.g., via computer program code or instructions) to provide stop classification and journey extraction as described herein and includes a communication mechanism such as a bus 1510 for passing information between other internal and external components of the computer system 1500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1510 includes one or more parallel conductors of information so that information is transferred quickly among devices coupled to the bus 1510. One or more processors 1502 for processing information are coupled with the bus 1510.

A processor 1502 performs a set of operations on information as specified by computer program code related to providing stop classification and journey extraction. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1510 and placing information on the bus 1510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1500 also includes a memory 1504 coupled to bus 1510. The memory 1504, such as a random access memory (RAM) or other dynamic storage device, stores information including processor instructions for providing stop classification and journey extraction. Dynamic memory allows information stored therein to be changed by the computer system 1500. RAM allows a unit of information stored at a location called a memory address to be stored and retrieved independently of information at neighboring addresses. The memory 1504 is also used by the processor 1502 to store temporary values during execution of processor instructions. The computer system 1500 also includes a read only memory (ROM) 1506 or other static storage device coupled to the bus 1510 for storing static information, including instructions, that is not changed by the computer system 1500. Some memory is composed of volatile storage that loses the information stored thereon when power is lost. Also coupled to bus 1510 is a non-volatile (persistent) storage device 1508, such as a magnetic disk, optical disk, or flash card, for storing information, including instructions, that persists even when the computer system 1500 is turned off or otherwise loses power.

Information, including instructions for providing stop classification and journey extraction, is provided to the bus 1510 for use by the processor from an external input device 1512, such as a keyboard containing alphanumeric keys operated by a human user, or a sensor. A sensor detects conditions in its vicinity and transforms those detections into physical expression compatible with the measurable phenomenon used to represent information in computer system 1500. Other external devices coupled to bus 1510, used primarily for interacting with humans, include a display device 1514, such as a cathode ray tube (CRT) or a liquid crystal display (LCD), or plasma screen or printer for presenting text or images, and a pointing device 1516, such as a mouse or a trackball or cursor direction keys, or motion sensor, for controlling a position of a small cursor image presented on the display 1514 and issuing commands associated with graphical elements presented on the display 1514. In some embodiments, for example, in embodiments in which the computer system 1500 performs all functions automatically without human input, one or more of external input device 1512, display device 1514 and pointing device 1516 is omitted.

In the illustrated embodiment, special purpose hardware, such as an application specific integrated circuit (ASIC) 1520, is coupled to bus 1510. The special purpose hardware is configured to perform operations not performed by processor 1502 quickly enough for special purposes. Examples of application specific ICs include graphics accelerator cards for generating images for display 1514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1500 also includes one or more instances of a communications interface 1570 coupled to bus 1510. Communication interface 1570 provides a one-way or two-way communication coupling to a variety of external devices that operate with their own processors, such as printers, scanners, and external disks. In general, the coupling is with a network link 1578 that is connected to a local network 1580 to which a variety of external devices with their own processors are connected. For example, communication interface 1570 may be a parallel port or a serial port or a universal serial bus (USB) port on a personal computer. In some embodiments, communications interface 1570 is an integrated services digital network (ISDN) card or a digital subscriber line (DSL) card or a telephone modem that provides an information communication connection to a corresponding type of telephone line. In some embodiments, a communication interface 1570 is a cable modem that converts signals on bus 1510 into signals for a communication connection over a coaxial cable or into optical signals for a communication connection over a fiber optic cable. As another example, communications interface 1570 may be a local area network (LAN) card to provide a data communication connection to a compatible LAN, such as Ethernet. Wireless links may also be implemented. For wireless links, the communications interface 1570 sends or receives or both sends and receives electrical, acoustic, or electromagnetic signals, including infrared and optical signals, that carry information streams, such as digital data. For example, in wireless handheld devices, such as mobile telephones like cell phones, the communications interface 1570 includes a radio band electromagnetic transmitter and receiver called a radio transceiver. In certain embodiments, the communications interface 1570 enables connection to the communication network 131 for providing stop classification and journey extraction.

The term computer-readable medium is used herein to refer to any medium that participates in providing information to processor 1502, including instructions for execution. Such a medium may take many forms, including, but not limited to, non-volatile media, volatile media, and transmission media. Non-volatile media include, for example, optical or magnetic disks, such as storage device 1508. Volatile media include, for example, dynamic memory 1504. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 1578 typically provides information communication using transmission media through one or more networks to other devices that use or process the information. For example, network link 1578 may provide a connection through local network 1580 to a host computer 1582 or to equipment 1584 operated by an Internet Service Provider (ISP). ISP equipment 1584 in turn provides data communication services through the public, world-wide packet-switching communication network of networks now commonly referred to as the Internet 1590.

A computer called a server host 1592 connected to the Internet hosts a process that provides a service in response to information received over the Internet. For example, server host 1592 hosts a process that provides information representing video data for presentation at display 1514. It is contemplated that the components of system can be deployed in various configurations within other computer systems, e.g., host 1582 and server 1592.

FIG. 16 illustrates a chip set 1600 upon which an embodiment of the invention may be implemented. Chip set 1600 is programmed to provide stop classification and journey extraction as described herein and includes, for instance, the processor and memory components described with respect to FIG. 15 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1600 includes a communication mechanism such as a bus 1601 for passing information among the components of the chip set 1600. A processor 1603 has connectivity to the bus 1601 to execute instructions and process information stored in, for example, a memory 1605. The processor 1603 may include one or more processing cores with each core configured to perform independently. A multi-core processor enables multiprocessing within a single physical package. Examples of a multi-core processor include two, four, eight, or greater numbers of processing cores. Alternatively or in addition, the processor 1603 may include one or more microprocessors configured in tandem via the bus 1601 to enable independent execution of instructions, pipelining, and multithreading. The processor 1603 may also be accompanied with one or more specialized components to perform certain processing functions and tasks such as one or more digital signal processors (DSP) 1607, or one or more application-specific integrated circuits (ASIC) 1609. A DSP 1607 typically is configured to process real-world signals (e.g., sound) in real time independently of the processor 1603. Similarly, an ASIC 1609 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1603 and accompanying components have connectivity to the memory 1605 via the bus 1601. The memory 1605 includes both dynamic memory (e.g., RAM, magnetic disk, writable optical disk, etc.) and static memory (e.g., ROM, CD-ROM, etc.) for storing executable instructions that when executed perform the inventive steps described herein to provide stop classification and journey extraction. The memory 1605 also stores the data associated with or generated by the execution of the inventive steps.

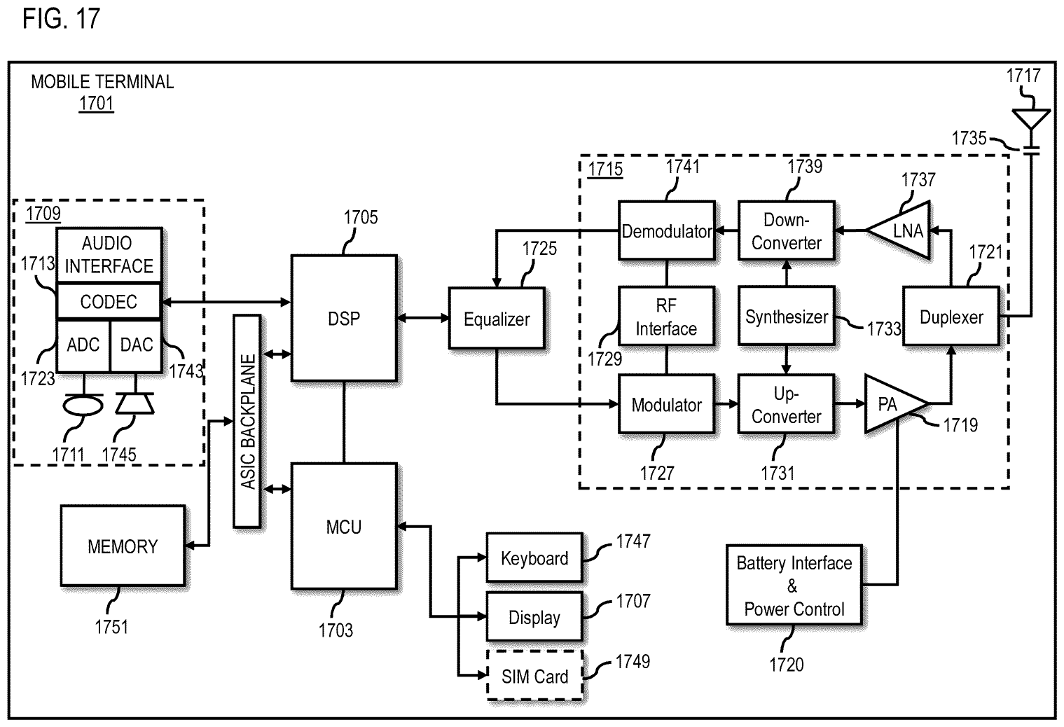

FIG. 17 is a diagram of exemplary components of a mobile terminal 1701 (e.g., a vehicles 101 and/or UE 117 or component thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1703, a Digital Signal Processor (DSP) 1705, and a receiver/transmitter unit including a microphone gain control unit and a speaker gain control unit. A main display unit 1707 provides a display to the user in support of various applications and mobile station functions that offer automatic contact matching. An audio function circuitry 1709 includes a microphone 1711 and microphone amplifier that amplifies the speech signal output from the microphone 1711. The amplified speech signal output from the microphone 1711 is fed to a coder/decoder (CODEC) 1713.

A radio section 1715 amplifies power and converts frequency in order to communicate with a base station, which is included in a mobile communication system, via antenna 1717. The power amplifier (PA) 1719 and the transmitter/modulation circuitry are operationally responsive to the MCU 1703, with an output from the PA 1719 coupled to the duplexer 1721 or circulator or antenna switch, as known in the art. The PA 1719 also couples to a battery interface and power control unit 1720.

In use, a user of mobile station 1701 speaks into the microphone 1711 and his or her voice along with any detected background noise is converted into an analog voltage. The analog voltage is then converted into a digital signal through the Analog to Digital Converter (ADC) 1723. The control unit 1703 routes the digital signal into the DSP 1705 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1725 for compensation of any frequency-dependent impairments that occur during transmission though the air such as phase and amplitude distortion. After equalizing the bit stream, the modulator 1727 combines the signal with a RF signal generated in the RF interface 1729. The modulator 1727 generates a sine wave by way of frequency or phase modulation. In order to prepare the signal for transmission, an up-converter 1731 combines the sine wave output from the modulator 1727 with another sine wave generated by a synthesizer 1733 to achieve the desired frequency of transmission. The signal is then sent through a PA 1719 to increase the signal to an appropriate power level. In practical systems, the PA 1719 acts as a variable gain amplifier whose gain is controlled by the DSP 1705 from information received from a network base station. The signal is then filtered within the duplexer 1721 and optionally sent to an antenna coupler 1735 to match impedances to provide maximum power transfer. Finally, the signal is transmitted via antenna 1717 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1701 are received via antenna 1717 and immediately amplified by a low noise amplifier (LNA) 1737. A down-converter 1739 lowers the carrier frequency while the demodulator 1741 strips away the RF leaving only a digital bit stream. The signal then goes through the equalizer 1725 and is processed by the DSP 1705. A Digital to Analog Converter (DAC) 1743 converts the signal and the resulting output is transmitted to the user through the speaker 1745, all under control of a Main Control Unit (MCU) 1703—which can be implemented as a Central Processing Unit (CPU) (not shown).

The MCU 1703 receives various signals including input signals from the keyboard 1747. The keyboard 1747 and/or the MCU 1703 in combination with other user input components (e.g., the microphone 1711) comprise a user interface circuitry for managing user input. The MCU 1703 runs a user interface software to facilitate user control of at least some functions of the mobile station 1701 to provide stop classification and journey extraction. The MCU 1703 also delivers a display command and a switch command to the display 1707 and to the speech output switching controller, respectively. Further, the MCU 1703 exchanges information with the DSP 1705 and can access an optionally incorporated SIM card 1749 and a memory 1751. In addition, the MCU 1703 executes various control functions required of the station. The DSP 1705 may, depending upon the implementation, perform any of a variety of conventional digital processing functions on the voice signals. Additionally, DSP 1705 determines the background noise level of the local environment from the signals detected by microphone 1711 and sets the gain of microphone 1711 to a level selected to compensate for the natural tendency of the user of the mobile station 1701.

The CODEC 1713 includes the ADC 1723 and DAC 1743. The memory 1751 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1751 may be, but not limited to, a single memory, CD, DVD, ROM, RAM, EEPROM, optical storage, or any other non-volatile or non-transitory storage medium capable of storing digital data.

An optionally incorporated SIM card 1749 carries, for instance, important information, such as the cellular phone number, the carrier supplying service, subscription details, and security information. The SIM card 1749 serves primarily to identify the mobile station 1701 on a radio network. The card 1749 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
processing vehicle location trace data to determine a sequence of vehicle stop locations, wherein the sequence of vehicle stop locations comprises a first stop location, a second stop location, and a third stop location in chronological order;
determining a first route cost from the first stop location to the third stop location via the second stop location;
determining a second route cost from the first stop location directly to the third stop location;
determining a classification of the second stop location as either a task stop or a rest stop based, at least in part, on a comparison of the first route cost and the second route cost; and
providing the classification as an output.

2. The method of claim 1, wherein the first route cost, the second route cost, or a combination thereof is based a route length, a travel time, a fuel consumption, a preference for a road that supports commercial vehicle traffic, or a combination thereof.

3. The method of claim 1, further comprising:
segmenting the vehicle location trace data into one or more journeys of a vehicle represented in the vehicle location trace data,
wherein the one or more journeys is a route segment starting from a first task stop and ending at a second task stop.

4. The method of claim 1, wherein the first route cost and the second route cost are determined using a routing engine.

5. The method of claim 1, wherein the first route cost is a first route length and the second route cost is a second route length, and wherein the first route length and the second route length are determined based on a geometric distance.

6. The method of claim 1, wherein the second stop location is classified as the task stop based on determining that a difference between the first route cost and the second route cost is greater than a threshold value.

7. The method of claim 6, further comprising:
dynamically determining the threshold value based on the second route cost.

8. The method of claim 1, further comprising:
querying a geographic database to determine one or more places within a threshold proximity of the second stop location,
wherein the classification of the second stop location is further based on the one or more places.

9. The method of claim 1, further comprising:
processing the vehicle location trace data to determine a stop arrival time, a stop departure time, or a combination thereof for the second stop location,
wherein the classification of the second stop location is further based on the stop arrival time, the stop departure time, or a combination thereof.

10. The method of claim 1, further comprising:
determining an inter-stop duration between the second stop location and another stop location,
wherein the classification of the second stop location is further based on the inter-stop duration.

11. The method of claim 1, further comprising:
determining a plurality of observations of the second stop location based on clustering the vehicle location trace data,
wherein the classification of the second stop location is based on arbitration of a plurality of stop classifications respectively associated with the plurality of observations.

12. The method of claim 1, wherein the classification is performed using a machine learning classifier.

13. The method of claim 1, wherein the vehicle location trace data is collected from one or more transport vehicles, wherein the task stop is a stop location at which the one or more transport vehicles perform a transport function, and wherein the rest stop is any other stop location that is not a task stop.

14. The method of claim 1, wherein the first stop location, the second stop location, and the third stop location are consecutive stop locations in the sequence of vehicle stop locations.

15. The method of claim 1, wherein the sequence of vehicle stop locations is processed using a three-stop location sliding window to determine a respective stop classification for each stop location in the sequence.

16. The method of claim 1, further comprising:
storing the classification as an attribute of the second stop location in a geographic database.

17. An apparatus comprising:
at least one processor; and
at least one memory including computer program code for one or more programs,
the at least one memory and the computer program code configured to, with the at least one processor, cause the apparatus to perform at least the following:
process vehicle location trace data to determine a sequence of vehicle stop locations, wherein the sequence of vehicle stop locations comprises a first stop location, a second stop location, and a third stop location in chronological order;
determine a first route cost from the first stop location to the third stop location via the second stop location;
determine a second route cost from the first stop location directly to the third stop location;
determine a classification of the second stop location as either a task stop or a rest stop based, at least in part, on a comparison of the first route length and the second route length; and
provide the classification as an output.

18. The apparatus of claim 17, wherein the apparatus is further caused to:
query a geographic database to determine one or more places within a threshold proximity of the second stop location,
wherein the classification of the second stop location is further based on the one or more places.

19. A non-transitory computer-readable storage medium carrying one or more sequences of one or more instructions which, when executed by one or more processors, cause an apparatus to at least perform the following steps:
processing vehicle location trace data to determine a sequence of vehicle stop locations, wherein the sequence of vehicle stop locations comprises a first stop location, a second stop location, and a third stop location in chronological order;
determining a first route cost from the first stop location to the third stop location via the second stop location;
determining a second route cost from the first stop location directly to the third stop location;
determining a classification of the second stop location as either a task stop or a rest stop based, at least in part, on a comparison of the first route length and the second route length; and
providing the classification as an output.

20. The non-transitory computer-readable storage medium of claim 19, wherein the apparatus is caused to further perform:
querying a geographic database to determine one or more places within a threshold proximity of the second stop location,
wherein the classification of the second stop location is further based on the one or more places.
